(19) United States
(12) Patent Application Publication
(10) Pub. No.: US 2021/0354344 A1
(43) Pub. Date: Nov. 18, 2021

(54) METHODS AND SYSTEMS TO PRODUCE LIGHTWEIGHT REINFORCED THERMOPLASTIC ARTICLES

(71) Applicants: Hongyu Chen, Forest, MA (US); Ruomiao Wang, Forest, VA (US); Mark O. Mason, Forest, VA (US)

(72) Inventors: Hongyu Chen, Forest, MA (US); Ruomiao Wang, Forest, VA (US); Mark O. Mason, Forest, VA (US)

(21) Appl. No.: 17/187,788

(22) Filed: Feb. 27, 2021

Related U.S. Application Data
(60) Provisional application No. 62/982,406, filed on Feb. 27, 2020.

(51) Int. Cl. B29C 43/34; B29C 43/00; B29C 43/52

(52) U.S. Cl. CPC B29C 43/34; B29C 43/003; B29K 2023/12; B29C 2043/3422; B29C 43/52

(57) ABSTRACT

Methods and systems that can produce light weight reinforced thermoplastic articles are described. In some embodiments, a method includes heating and pressing a core layer and then cooling and pressing the core layer to maintain the thickness of the core layer during cooling. Automotive articles, building articles and recreational vehicle articles that can be produced using the methods and systems are also described.

### PRIORITY APPLICATION

This application claims priority to, and the benefit of, U.S. Provisional Application No. 62/982,406 filed on Feb. 27, 2020, the entire disclosure of which is hereby incorporated herein by reference.

### TECHNOLOGICAL FIELD

Certain configurations described herein are directed to methods of producing lightweight reinforced thermoplastic articles. In some instances, the articles can be produced using two or more press devices.

### BACKGROUND

Lightweight reinforced thermoplastic (LWRT) articles or composites are widely used in the many industries as a result of being lightweight but still having desired mechanical properties.

### SUMMARY

Certain aspects of processes of producing LWRT articles are described which can use a first press device and a second press device. Inline systems designed to perform the processes can be used to produce the LWRT articles in an automated manner.

In an aspect, an inline process for producing a lightweight thermoplastic composite article using an inline system is described. In certain configurations, the inline process comprises combining reinforcing materials and a thermoplastic material in a liquid to produce an aqueous foam, depositing the aqueous foam onto a moving support of the inline system. The process can also comprise, removing liquid from the deposited aqueous foam on the moving support to form a web of open cell structures formed from the thermoplastic material and the reinforcing materials. The process can also comprise providing the formed web on the moving support of the inline system to a first press device of the inline system at a first pressure and a first temperature to apply heat and pressure to the formed web using the first press device, wherein the first temperature and first pressure are selected to melt the thermoplastic material of formed web. The process can also comprise providing the heated web to a second press device of the inline system at a second temperature and a second pressure to cool the heated web using the second press device, wherein the second temperature is below the melting point of the thermoplastic material of the heated web, wherein the second pressure is equal to or less than the first pressure, and wherein cooling of the heated web using the second press device provides a cooled web comprising a substantially similar thickness as the heated web. The process can also comprise discharging the cooled web from the inline system to provide the lightweight thermoplastic composite article.

In certain configurations, the first pressure is greater than 1.1 bar or is about 2 bar to about 30 bar or is about 3 bar to about 25 bar or is about 3 bar to about 15 bar. In other examples, the first temperature is about 170 degrees Celsius to and about 250 degrees Celsius or about 170 degrees Celsius to about 240 degrees Celsius or about 170 degrees Celsius to about 230 degrees Celsius or about 170 degrees Celsius to about 220 degrees Celsius or about 170 degrees Celsius to about 210 degrees Celsius or about 170 degrees Celsius to about 200 degrees Celsius. In some instances, the second temperature is less than a melting temperature of the thermoplastic material or is less than 170 degrees Celsius or is less than 160 degrees Celsius or less than 150 degrees Celsius or is less than 140 degrees Celsius or is less than 130 degrees Celsius or less than 120 degrees Celsius or is less than 110 degrees Celsius or is less than 90 degrees Celsius or less than 80 degrees Celsius or is less than 70 degrees Celsius or is less than 60 degrees Celsius or less than 50 degrees Celsius or is less than 45 degrees Celsius or is between 5 degrees Celsius and 45 degrees Celsius. In some embodiments, the method comprises cutting the cooled web into individual lightweight thermoplastic composite articles using the inline system, and discharging the individual lightweight thermoplastic composite article from the inline system. In some configurations, the first press device is configured to apply pressure to the heated web at the first temperature and the first pressure by sandwiching the formed web between an upper plate and a lower plate. In other configurations, the second press device is configured to apply pressure to the heated web at the second temperature and the second pressure by sandwiching the heated web between an upper plate and a lower plate.

In some examples, the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to apply the first pressure to the formed web as the formed web passes between the set of upper rollers and the set of lower rollers of the first press device.

In other examples, the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to apply the second pressure to the heated web received from the first press device as the heated web passes between the set of upper rollers and the set of lower rollers of the second press device.

In some embodiments, the system comprises at least one set of rollers to select a thickness of the formed web prior to providing the formed web to the first press device.

In another aspect, an inline process for producing a lightweight thermoplastic composite article using an inline system comprises combining reinforcing materials and a thermoplastic material in a liquid to produce an aqueous foam, depositing the aqueous foam onto a moving support of the inline system, removing liquid from the deposited aqueous foam on the moving support to form a web of open cell structures formed from the thermoplastic material and the reinforcing materials, disposing a first skin on a first surface of the formed web, providing the formed web and disposed first skin on the moving support of the inline system to a first press device of the inline system to apply heat and pressure to the formed web and disposed first skin at a first pressure and a first temperature using the first press device, wherein the first temperature and first pressure are selected to melt the thermoplastic material of formed web, providing the heated web and disposed first skin to a second press device of the inline system at a second temperature to cool the heated web and disposed skin and apply pressure to the heated web at a second pressure using the second press device, wherein cooling of the heated web provides a cooled web comprising a substantially similar thickness as the heated web, wherein the second pressure is equal to or less than the first pressure, and discharging the cooled web from the inline system to provide the lightweight thermoplastic composite article.

In certain configurations, the first pressure is greater than 1.1 bar or is about 2 bar to about 30 bar or is about 3 bar to about 25 bar or is about 3 bar to about 15 bar. In other examples, the first temperature is about 170 degrees Celsius to and about 250 degrees Celsius or about 170 degrees Celsius to about 240 degrees Celsius or about 170 degrees Celsius to about 230 degrees Celsius or about 170 degrees Celsius to about 220 degrees Celsius or about 170 degrees Celsius to about 210 degrees Celsius or about 170 degrees Celsius to about 200 degrees Celsius. In some instances, the second temperature is less than a melting temperature of the thermoplastic material or is less than 170 degrees Celsius or is less than 160 degrees Celsius or less than 150 degrees Celsius or is less than 140 degrees Celsius or is less than 130 degrees Celsius or less than 120 degrees Celsius or is less than 110 degrees Celsius or is less than 90 degrees Celsius or less than 80 degrees Celsius or is less than 70 degrees Celsius or is less than 60 degrees Celsius or less than 50 degrees Celsius or is less than 45 degrees Celsius or is between 5 degrees Celsius and 45 degrees Celsius. In some embodiments, the method comprises cutting the cooled web into individual lightweight thermoplastic composite articles using the inline system, and discharging the individual lightweight thermoplastic composite article from the inline system. In some configurations, the first press device is configured to apply pressure to the heated web at the first temperature and the first pressure by sandwiching the formed web between an upper plate and a lower plate. In other configurations, the second press device is configured to apply pressure to the heated web at the second temperature and the second pressure by sandwiching the heated web between an upper plate and a lower plate.

In some examples, the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to apply the first pressure to the formed web as the formed web passes between the set of upper rollers and the set of lower rollers of the first press device.

In other examples, the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to apply the second pressure to the heated web received from the first press device as the heated web passes between the set of upper rollers and the set of lower rollers of the second press device.

In some embodiments, the system comprises at least one set of rollers to select a thickness of the formed web prior to providing the formed web to the first press device.

In other configurations, the method comprises disposing a second skin on a second surface of the formed web prior to providing the formed web and disposed first skin to the first press device.

In some embodiments, the first pressure is greater than 1.1 bar or is about 2 bar to about 30 bar or is about 3 bar to about 25 bar or is about 3 bar to about 15 bar. In other examples, the first temperature is about 170 degrees Celsius to and about 250 degrees Celsius or about 170 degrees Celsius to about 240 degrees Celsius or about 170 degrees Celsius to about 230 degrees Celsius or about 170 degrees Celsius to about 220 degrees Celsius or about 170 degrees Celsius to about 210 degrees Celsius or about 170 degrees Celsius to about 200 degrees Celsius. In some instances, the second temperature is less than a melting temperature of the thermoplastic material or is less than 170 degrees Celsius or is less than 160 degrees Celsius or less than 150 degrees Celsius or is less than 140 degrees Celsius or is less than 130 degrees Celsius or less than 120 degrees Celsius or is less than 110 degrees Celsius or is less than 90 degrees Celsius or less than 80 degrees Celsius or is less than 70 degrees Celsius or is less than 60 degrees Celsius or less than 50 degrees Celsius or is less than 45 degrees Celsius or is between 5 degrees Celsius and 45 degrees Celsius. In some embodiments, the method comprises cutting the cooled web into individual lightweight thermoplastic composite articles using the inline system, and discharging the individual lightweight thermoplastic composite article from the inline system. In some configurations, the first press device is configured to apply pressure to the heated web at the first temperature and the first pressure by sandwiching the formed web between an upper plate and a lower plate. In other configurations, the second press device is configured to apply pressure to the heated web at the second temperature and the second pressure by sandwiching the heated web between an upper plate and a lower plate.

In some examples, the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to apply the first pressure to the formed web as the formed web passes between the set of upper rollers and the set of lower rollers of the first press device.

In other examples, the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to apply the second pressure to the heated web received from the first press device as the heated web passes between the set of upper rollers and the set of lower rollers of the second press device.

In some embodiments, the system comprises at least one set of rollers to select a thickness of the formed web prior to providing the formed web to the first press device.

In other configurations, the method comprises disposing a second skin on a second surface of the formed web prior to providing the formed web and disposed first skin to the first press device.

In another aspect, an inline system for producing a lightweight thermoplastic comprises a mixing reservoir configured to receive a thermoplastic material and reinforcing materials to provide a substantially homogeneous liquid dispersion of the thermoplastic material and the reinforcing material. The system can also include a moving support fluidically coupled to the mixing reservoir and configured to receive the substantially homogeneous liquid dispersion from the mixing reservoir. The system can also include a pressure device configured to remove liquid from the liquid dispersion received by the moving support to provide a web of open cell structures formed from the thermoplastic material and the reinforcing materials. The system can also include a first press device configured to receive the formed web and provide heat and pressure to the formed web using a first temperature and a first pressure. The system can also include a second press device configured to receive the heated web from the first press device and cool the heated web using a second temperature and a second pressure.

In certain embodiments, the second press device is configured to cool the web at the second pressure to prevent any substantial change in thickness of the heated web after heating and pressing using the first press device.

In other embodiments, the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to provide the first pressure to the formed web as the formed web passes between the set of upper rollers and the set of lower rollers of the first press device.

In some configurations, the second press device and the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to provide the second pressure to the heated web received from the first press device as the heated web passes between the set of upper rollers and the set of lower rollers of the second press device.

In additional configurations, the first press device and the second press device are part of a belt feeder device. In some examples, the first press device comprises an upper plate and a lower plate that sandwich the formed web on the belt feeder device. In additional examples, the second press device comprises an upper plate and a lower plate that sandwich the heated web on the belt feeder device.

In some embodiments, the first press device and the second press device are each configured to sandwich the formed web in a direction parallel to a moving direction of the moving support.

In certain embodiments, at least one of the first press device and the second press device is configured to sandwich the formed web in a direction non-parallel to a moving direction of the moving support.

In other examples, the system comprises a set of rollers configured to select a thickness of the formed web prior to providing the formed web to the first press device.

In some examples, a system for producing a lightweight thermoplastic composite article comprises a first sub-system comprising a mixing reservoir configured to receive a thermoplastic material and reinforcing materials to provide a substantially homogeneous liquid dispersion of the thermoplastic material and the reinforcing material, a moving support fluidically coupled to the mixing reservoir and configured to receive the substantially homogeneous liquid dispersion from the mixing reservoir, and a pressure device configured to remove liquid from the liquid dispersion received by the moving support to provide a web of open cell structures formed from the thermoplastic material and the reinforcing materials. A second sub-system comprises a first press device configured to receive the formed web from the first sub-system and provide heat and pressure to the formed web using a first temperature and a first pressure, and a second press device configured to receive the heated web from the first press device and cool the heated web using a second temperature and a second pressure.

In certain configurations, the second press device is configured to cool the web at the second pressure to prevent any substantial change in thickness of the heated web after heating and pressing using the first press device. In other configurations, the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to provide the first pressure to the formed web as the formed web passes between the set of upper rollers and the set of lower rollers of the first press device. In some embodiments, the second press device and the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to provide the second pressure to the heated web received from the first press device as the heated web passes between the set of upper rollers and the set of lower rollers of the second press device.

In certain examples, the first press device and the second press device are part of a belt feeder device. In some examples, the first press device comprises an upper plate and a lower plate that sandwich the formed web on the belt feeder device. In other examples, the second press device comprises an upper plate and a lower plate that sandwich the heated web on the belt feeder device. In some embodiments, the first press device and the second press device are each configured to sandwich the formed web in a direction parallel to a moving direction of the moving support. In other embodiments, at least one of the first press device and the second press device is configured to sandwich the formed web in a direction non-parallel to a moving direction of the moving support. In some examples, the system comprises a set of rollers configured to select a thickness of the formed web prior to providing the formed web to the second sub-system.

In an additional aspect, a process of forming a lightweight thermoplastic composite article comprising a web of open cell structures formed from reinforcing materials held in place by a thermoplastic material comprises heating the web to a first temperature above a melting point of the thermoplastic material, applying a first pressure at the first temperature to provide a heated web with a first thickness, cooling the heated web to a second temperature below the melting point of the thermoplastic material, and applying a second pressure at the second temperature to cool the heated web and provide a lightweight thermoplastic composite article with the first thickness, wherein the second pressure is equal to or less than the first pressure.

In other aspects, lightweight reinforced thermoplastic composite article comprise a core layer produced using any one of the processes described herein. In certain configurations, .the density of the core layer is 0.2 gm/cm³ to 1.5 gm/cm³. In some examples, a thermoplastic material of the core layer comprises a polyolefin or a polyetherimide or both. In other examples, reinforcing materials of the core layer comprise glass fibers, polymeric fibers, bicomponent fibers and/or mixtures thereof. In certain embodiments, a lofting agent can be present in the core layer. In some instances, at least one skin layer is disposed on the core layer.

In another aspect, an automotive headliner comprises a core layer produced using the methods and systems described herein.

In an additional aspect, an automotive underbody shield comprises a core layer produced using the methods and systems described herein.

In another aspect, an automotive vehicle trim piece comprises a core layer produced using the methods and systems described herein.

In an additional aspect, a ceiling tile comprises a core layer produced using the methods and systems described herein.

In another aspect, a cubicle panel comprises a core layer produced using the methods and systems described herein.

In an additional aspect, a structural panel comprises a core layer produced using the methods and systems described herein.

In another aspect, a wall panel comprises a core layer produced using the methods and systems described herein.

In an additional aspect, a siding panel comprises a core layer produced using the methods and systems described herein.

In another aspect, a roofing panel comprises a core layer produced using the methods and systems described herein.

In an additional aspect, a roofing shingle comprises a core layer produced using the methods and systems described herein.

In another aspect, a recreational vehicle comprises a core layer produced using the methods and systems described herein.

In an additional aspect, an aerospace vehicle interior panel comprises a core layer produced using the methods and systems described herein.

In another aspect, a recreational vehicle exterior panel comprises a core layer produced using the methods and systems described herein.

In an additional aspect, an aerospace vehicle exterior panel comprises a core layer produced using the methods and systems described herein.

In another aspect, a recreational vehicle comprises a core layer produced using the methods and systems described herein.

In an additional aspect, an aerospace vehicle comprises a core layer produced using the methods and systems described herein.

In an additional aspect, an automotive vehicle comprises a core layer produced using the methods and systems described herein.

In another aspect, a recreational vehicle comprises a trim piece that comprises a core layer produced using the methods and systems described herein.

In an additional aspect, an aerospace vehicle comprises a trim piece that In an additional aspect, an aerospace vehicle comprises a core layer produced using the methods and systems described herein.

Additional aspect, embodiments, configurations, and features are described in more detail below.

### BRIEF DESCRIPTION OF THE SEVERAL VIEWS OF THE DRAWINGS

Certain specific configurations are described below with reference to the accompanying drawings in which:

FIG. 1 is an illustration of a first press device and a second press device in accordance with some examples;

FIG. 2 is an illustration of flow chart of one process than can be used to produce a LWRT article, in accordance with some embodiments;

FIG. 3 is another illustration of flow chart of one process than can be used to produce a LWRT article, in accordance with certain embodiments;

FIG. 4 is another illustration of flow chart of one process than can be used to produce a LWRT article, in accordance with other embodiments;

FIG. 5 is a flow chart showing a process where a dried web can be heated and pressed and then cooled and pressed, in accordance with some embodiments;

FIGS. 6A, 6B, 6C, 6D, and 6E shows a core layer optionally in combination with other layers, in accordance with some embodiments;

FIGS. 7, 8, 9, and 10 are illustration of systems comprising a first press device and a second press device, in accordance with certain embodiments;

FIG. 11 is an illustration of a system comprising two sub-systems, in accordance with certain embodiments;

FIG. 12 is an illustration of a vehicle headliner, in accordance with some examples;

FIG. 13A is an illustration of an underbody shield and FIG. 13B is an illustration of a trim piece, in accordance with some embodiments;

FIG. 14 is an illustration of a ceiling tile, in accordance with some examples;

FIG. 15 is an illustration of a cubicle panel, in accordance with some examples;

FIG. 16A and 16B are illustration of a structural panel, in accordance with some examples;

FIG. 17 is an illustration of a wall panel, in accordance with certain embodiments;

FIG. 18 is an illustration of a siding panel, in accordance with some embodiments;

FIG. 19 is an illustration of a roofing panel, in accordance with some examples;

FIG. 20 is an illustration of a roofing shingle, in accordance with some examples;

FIG. 21A is an illustration of an interior panel, in accordance with some embodiments;

FIG. 21B is an illustration of an exterior panel, in accordance with some embodiments;

FIGS. 22A, 22B, 22C and 22D are illustrations of vehicles that can include a core layer produced as described herein, in accordance with certain embodiments;

FIG. 23 is an illustration of interior trim, in accordance with certain examples;

FIGS. 24A, 24B, 24C, 24D and 24E shows various core layers, in accordance with certain examples;

FIG. 25 is an illustration of a core layer coupled to a scrim and a film, in accordance with some embodiments;

FIGS. 26A, 26B, 27A, 27B and 28A and 28B show various surface morphologies of tested samples, in accordance with some examples,

FIGS. 29A, 29B, 30A, 30B and 31A and 31B show various mechanical properties for tested samples, in accordance with certain embodiments; and

FIGS. 32A, 32B, 33A, 33B, 34A and 34B shows various measured tensile properties for tested samples, in accordance with some embodiments.

It will be recognized by the person having ordinary skill in the art, given the benefit of this disclosure that the dimensions, sizes, shading, arrangement and other features in the figures are provided merely for illustration and are not intended to limit the technology to any one configuration.

### DETAILED DESCRIPTION

While certain specific configurations and embodiments are described below of steps and methods that can be used to produce LWRT articles, additional steps and other processing conditions, temperatures and pressures will be selected by the person having ordinary skill in the art, given the benefit of this disclosure.

In certain embodiments, the inline methods described herein can produce lightweight thermoplastic composite article comprising a web of open cell structures formed from reinforcing materials held in place by a thermoplastic material. Illustrative reinforcing materials and thermoplastic materials are discussed in more detail below. While the specific steps may vary depending on the nature of the LWRT article to be produced, the method can include heating the formed web to a first temperature above a melting point of the thermoplastic material in the formed web, applying a first pressure at the first temperature to provide a heated web with a first thickness, cooling the heated web to a second temperature below the melting point of the first temperature, and applying the first pressure (or a pressure less than the first pressure) at the second temperature to cool the heated web and provide a lightweight thermoplastic composite article with the first thickness.

In some instances, the heated web is directly transferred from a heated press device to a cooled press device without any intermediate processing steps. For example, the formed web can be provided to a first press device, e.g., a hydraulic press, a mechanical press, sets of upper and lower rollers, or other suitable presses and devices, that can apply pressure and heat to surfaces of formed web. The pressure can be used to press the web to a desired thickness which can vary, for example, from about 100 microns up to about 10 mm. The first press device typically is held at a first temperature above a melting temperature of the thermoplastic material of the formed web to permit wet out of the reinforcing materials of the formed web with the thermoplastic material. A heated web of a desired thickness can then be transferred a colder second press device, which is typically at a second temperature below the melting temperature of the thermoplastic material of the heated web, to permit the heated web to solidify. The second press device can apply a pressure, which is typically the same as or less than the pressure applied by the first press device, to maintain substantially the same thickness that was selected using the first press device. For example, the thickness of an LWRT article produced using a first press device and a second press device may vary up to about 5% after heating and cooling of the LWRT article.

In some embodiments as noted in more detail below, the first press device can heat the LWRT article to a sufficient temperature to melt the thermoplastic material but not so high as to loft any lofting agents that may be present in the LWRT. While the exact temperature can vary depending on the materials present in the LWRT article, illustrative temperatures used with the first press device can vary from about 170 degrees Celsius to about 240 degrees Celsius or about 180 degrees Celsius to about 220 degrees Celsius. The pressure provided by the first press device can vary from about 2 bar to about 20 bar, more particularly about 3 bar to about 15 bar. The temperature of the second press device is typically lower than the first press device to permit the heated web to cool. For example, the temperature of the second press device can be less than 180 degrees Celsius, less than 150 degrees Celsius, less than 125 degrees Celsius or even closer to room temperature, e.g., can be about 5 degrees Celsius to about 45 degrees Celsius. The pressure provided by the second press device is typically the same as or less than the pressure provided by the first press device. Without wishing to be bound by any one configuration, it may be desirable to use as low a pressure as possible in the second press device while still maintaining about the same thickness for the heated web. By using a second pressure in the second press device that is as low as possible while maintaining about the same thickness for the heated web, simpler and cheaper devices can be used as a second press device.

In certain examples, the formed web that exits the second press device can be subjected to further processing steps including lofting, consolidation, lamination, cutting or other steps as desired. In some instances, one or more skins can be applied to one or more surfaces of the formed web after it exits the second press device, whereas in other instances one or more skins can be applied prior to heating and pressing the formed web using the first press device. The process of heating and pressing the webs, and optionally other post-processing steps, can be performed off line or in an inline process that can be automated to increase production of the LWRT articles.

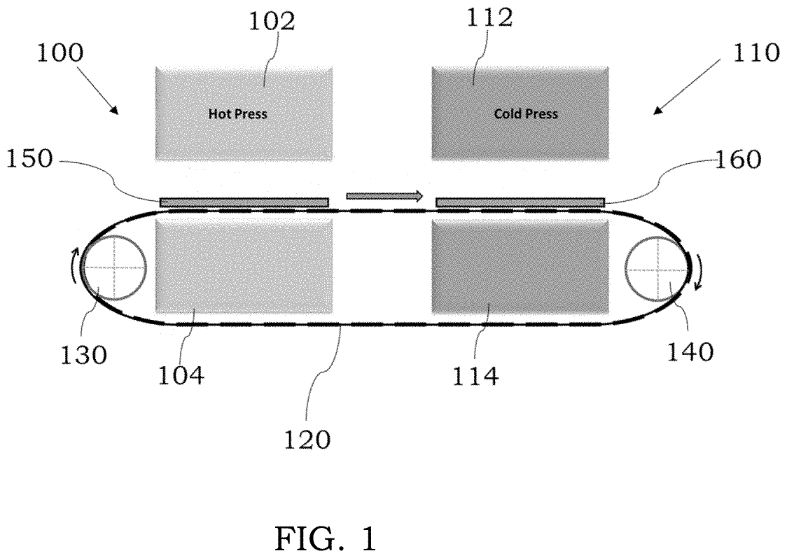

In offline processes, the heating and pressing can be performed by transferring the formed web (or formed LWRT article) to the first and second press devices as shown in FIG. 1. For example, a first press device 100 may comprise an upper plate 102 and a lower plate 104, A second press 110 may comprise an upper plate 112 and a lower plate 114. A rotating belt 120 that is moved around pulleys or rollers 130, 140 can advance a heated web 150 from the first press device 100 to the second press device 110. The temperature provided by the plates 102, 104 is typically above the melting temperature of the thermoplastic material in the formed web, e.g., 170-240 degrees Celsius. After pressing and cooling, a cooled web 160 can exit the belt 120 and be collected in a container, stacked or palletized as desired. The first press device 100 can press the web 150 between the upper plate 102, the belt 120 and the lower plate 104 to a desired thickness using a first pressure, e.g., 2 bar to about 20 bar. Similarly, the second press device 110 can press the web between the upper plate 112, the belt 120 and the lower plate 104 to cool the web to a second temperature and to maintain the thickness of the web, e.g., the second press device 110 can apply a second pressure which is the same as or less than the first pressure, e.g., 2 bar to 20 bar. The temperature of the plates 112, 114 of the second press device 110 is typically below a melting temperature of the thermoplastic material in the heated web to permit solidification of the web. Rotation of the belt 120 can be stopped during the pressing steps if desired.

In another configuration, the belt 120 can be omitted entirely, and an operator can manually place the formed web between the plates 102, 104 to heat and press the formed web using a first temperature and a first pressure. Once the web is heated, the plates 102, 104 can be moved away from each other, and a peel, paddle or other transfer device, which is preferably non-stick, can be used to remove the heated web from the first press device 100 and transfer it to the second press device 110. The plates 112, 114 can be used to cool and apply pressure to the transferred web at second pressure, which is typically the same as or lower than the first pressure provided by the first press device 100, to cool the web while maintaining about the same thickness. Once the web is cooled, the plates 112, 114 can be moved away from each other, and the resulting formed LWRT can be removed from the second press device 110 and stacked or palletized if desired. While not shown, a release liner can be present on surfaces of the plates 102, 104, 112, 114 that contact the formed web to prevent sticking of the formed web to the plates 102, 104, 112, 114. Alternatively, a release liner can be added to one or both surfaces of the formed web prior to pressing and heating.

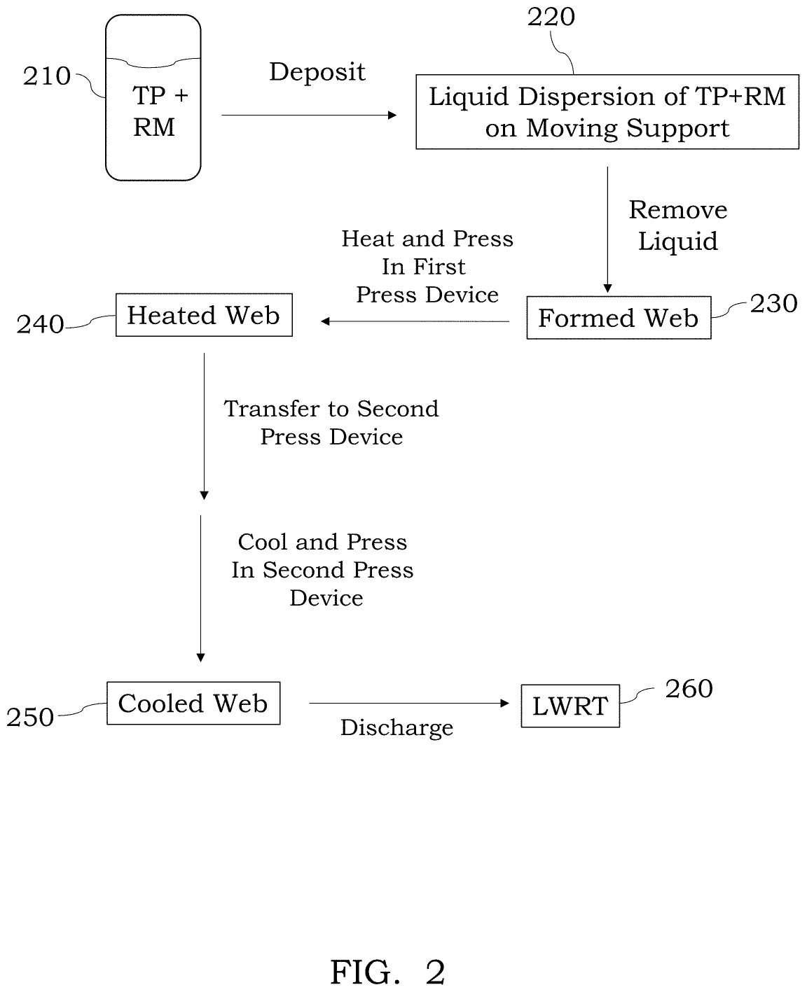

In certain embodiments, a flow chart of a process to produce a LWRT article is shown in FIG. 2. At a step 210, thermoplastic material (TP) and reinforcing materials (RM) are combined together in a liquid. The combined materials can then be deposited on a moving support, e.g., a wire screen or mesh, at a step 220. The liquid, but not the TP or RM, can be removed from the moving support, e.g., using vacuum pressure or the like, to leave behind a web formed from the TP and RM at a step 230. The formed web can be heated and pressed using a first press device at a first temperature and a first pressure to form a heated web at a step 240. The first temperature can be selected to be above the melting temperature of the TP in the formed web, e.g., about 170 degrees Celsius to about 240 degrees Celsius. The first pressure can be selected to press the heated web to a desired overall thickness, e.g., about 100 microns to about 10 mm. Heating of the formed web in the first press device can melt the TP material and provide improved wet out of the reinforcing material. The heated web can then be transferred to a second press device at a second temperature than the first temperature to cool the heated web and form a cooled web at a step 250. The second press can apply a second pressure, which can equal to or less than the first pressure, to maintain the thickness of the heated web during the cooling process. Once cooled, the cooled web can be discharged as a LWRT at a step 260. As noted herein, this process can be performed as an inline process using an inline system or one or more steps can be performed offline.

In certain embodiments, another flow chart of a process to produce a LWRT article is shown in FIG. 3. At a step 310, thermoplastic material (TP) and reinforcing materials (RM) are combined together in a liquid. The combined materials can then be deposited on a moving support, e.g., a wire screen or mesh, at a step 320. The liquid, but not the TP or RM, can be removed from the moving support, e.g., using vacuum pressure or the like, to leave behind a web formed from the TP and RM at a step 330. A skin such as a scrim, film or other skin discussed herein can then be added to one surface of the core at a step 335. The formed web and skin can be heated and pressed using a first press device at a first temperature and a first pressure to form a heated web and skin at a step 340. The first temperature can be selected to be above the melting temperature of the TP in the formed web, e.g., about 170 degrees Celsius to about 240 degrees Celsius. The first pressure can be selected to press the heated web and skin to a desired overall thickness, e.g., about 100 microns to about 10 mm. Heating of the formed web and skin in the first press device can melt the TP material and provide improved wet out of the reinforcing material. The heated web and skin can then be transferred to a second press device at a second temperature lower than the first temperature to cool the heated web and form a cooled web and skin at a step 350. The second press can apply a second pressure, which can equal to or less than the first pressure, to maintain the thickness of the heated web and skin during the cooling process. Once cooled, the cooled web and skin can be discharged as a LWRT article at a step 360. As noted herein, this process can be performed as an inline process using an inline system or one or more steps can be performed offline.

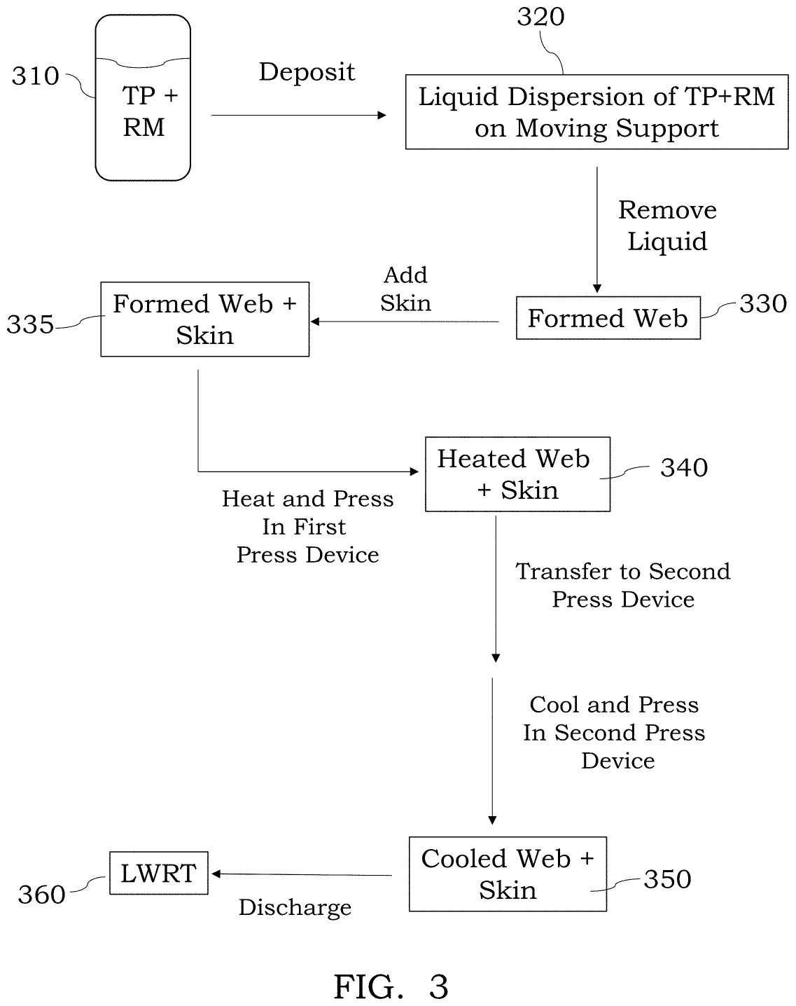

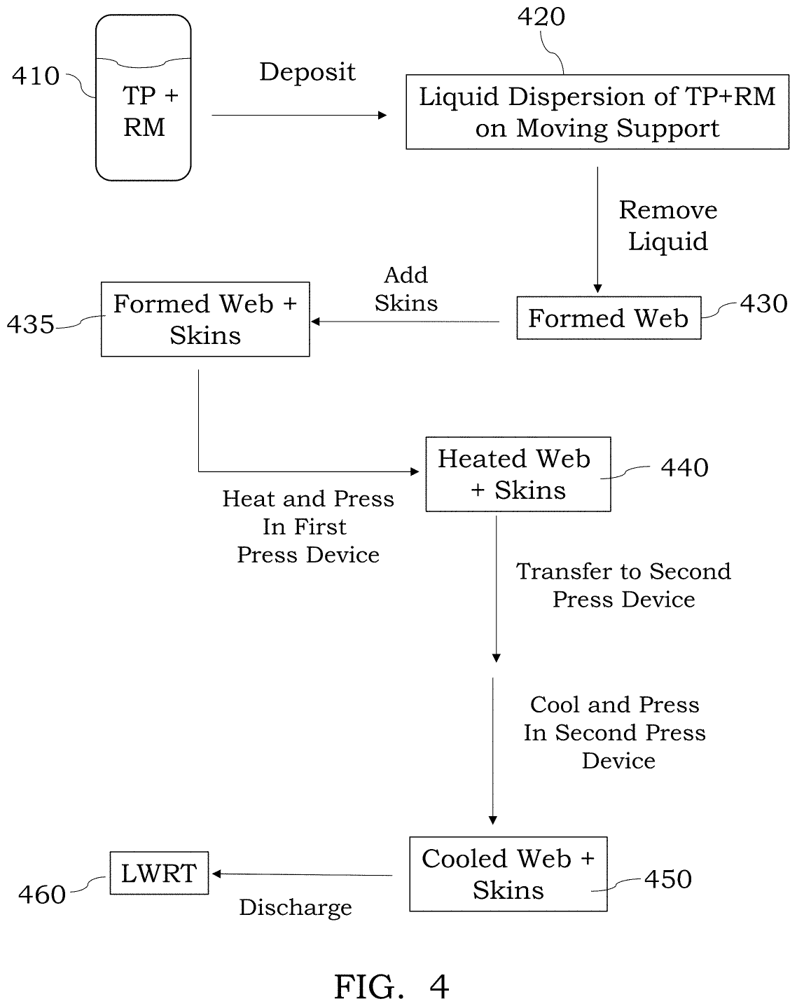

In another embodiment, an additional flow chart of a process to produce a LWRT article is shown in FIG. 4. At a step 410, thermoplastic material (TP) and reinforcing materials (RM) are combined together in a liquid. The combined materials can then be deposited on a moving support, e.g., a wire screen or mesh, at a step 420. The liquid, but not the TP or RM, can be removed from the moving support, e.g., using vacuum pressure or the like, to leave behind a web formed from the TP and RM at a step 430. A skin such as a scrim, film or other skin discussed herein can then be added to each side or surface of the core at a step 435. The two skins can be the same or can be different as noted below. The formed web and skins can be heated and pressed using a first press device at a first temperature and a first pressure to form a heated web and skins at a step 440. The first temperature can be selected to be above the melting temperature of the TP in the formed web, e.g., about 170 degrees Celsius to about 240 degrees Celsius. The first pressure can be selected to press the heated web and skins to a desired overall thickness, e.g., about 100 microns to about 10 mm. Heating of the formed web and skins in the first press device can melt the TP material and provide improved wet out of the reinforcing material. The heated web and skins can then be transferred to a second press device at a second temperature than the first temperature to cool the heated web and form a cooled web and skins at a step 450. The second press can apply a second pressure, which can equal to or less than the first pressure, to maintain the thickness of the heated web and skins during the cooling process. Once cooled, the cooled web and skins can be discharged as a LWRT article at a step 460. As noted herein, this process can be performed as an inline process using an inline system or one or more steps can be performed offline.

In certain embodiments, the formed web may be dried or processed prior to providing it to the first press. For example and referring to FIG. 5, a formed web 510 can be dried to provide a dried web at a step 520. Water or other liquids can be removed using heat, pressure, suction, rollers, air streams or other devices or materials. If desired, the dried web can be placed between rollers to ring out any excess liquid or pre-compress the dried web. The dried web can then be provided to the first press device and heated and pressed to form a heated web at a step 530. The heated web can then be transferred to a second press device and cooled and pressed to maintain its thickness and form a cooled web 540. The cooled web can be discharged to form a LWRT at a step 550.

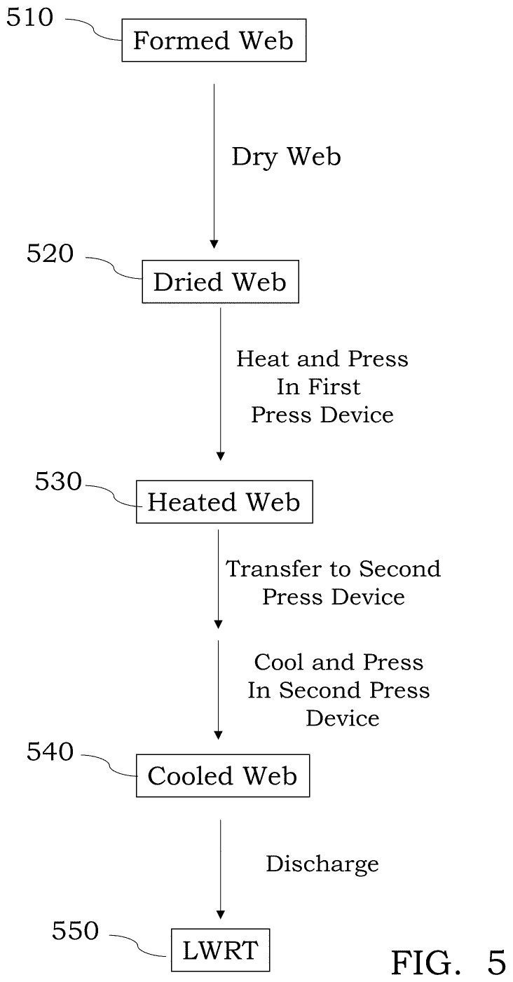

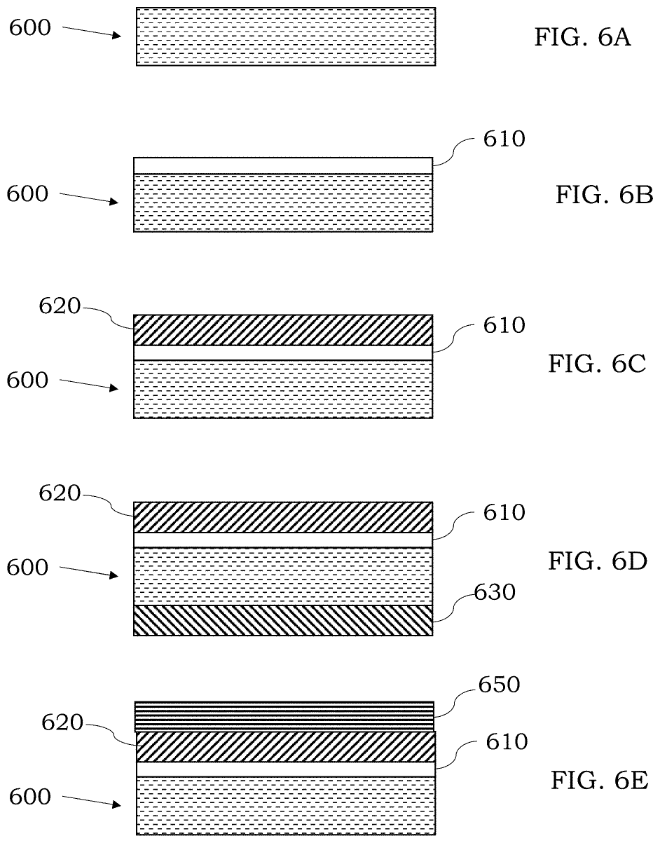

The exact configuration and materials of an LWRT article can vary depending on material used, the intended use of the LWRT article and/or desired properties for the LWRT article. In certain examples, a thermoplastic composite article comprises reinforcing materials, e.g., powders, whiskers, fibers, etc. and a thermoplastic material. A simplified illustration is shown in FIG. 6A, where the article 600 comprises a porous core layer comprising reinforcing fibers and the thermoplastic material. The reinforcing fibers and thermoplastic material may form a web of open cell structures where the reinforcing fibers are held in place by the thermoplastic material. The web may be porous as a result of the formed open cell structures. For example, a porosity or void content of the porous core layer may be 0-30%, 10-40%, 20-50%, 30-60%, 40-70%, 50-80%, 60-90%, 0-40%,0-50%,0-60%,0-70%,0-80%,0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. In some instances, the porous core layer comprises a porosity or void content of greater than 0%, e.g., is not fully consolidated, up to about 95%. Unless otherwise stated, the reference to the core layer comprising a certain void content or porosity is based on the total volume of the core layer and not necessarily the total volume of the core layer plus any other materials or layers coupled to the core layer. While not necessarily true in all instances, post-consolidation of the core 600 using a hot press device can decrease the porosity compared to the same core layer that has not been consolidated. Even when consolidation is performed using a hot press device and a cold press device, the resulting porosity of the consolidated core can still remain above 25%, 30%, 35%, 40%, 45%, 50%, 55%, 60% or even 65% based on the total volume of the core layer 600. In other instances, the core layer 600 could be fully consolidated such that porosity is 0% with only minimal or no void space present in the core layer 600.

In certain embodiments, the thermoplastic material present in the core layer 600 may comprise different forms including, but not limited to, fiber form, particle form, resin form or other suitable forms. In some examples, the thermoplastic material may comprise a polyolefin or other thermoplastic materials. For example, the thermoplastic material may comprise one or more of polyethylene, polypropylene, polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as alloys and blends of these materials with each other or other polymeric materials In some instances, the resin may be a polyetherimide resin such as an Ultem® resin. The Ultem® resin can be filled or unfilled may be selected so it is UL94 V-0 rated with low smoke KPSI FDA, USDA, USP Class VI & NSF Approved. If desired, the Ultem® resin may be glass-reinforce, e.g., 30% glass-filled (Ultem 2300), 20% glass-filled (Ultem 2200), or 10% glass-filled (Ultem 2100). If desired, a thermoplastic blend, which can be a blend including a thermoplastic material or a thermosetting material, may be present in the core layer 600. The exact amount of thermoplastic material in the core layer 600 may vary and includes, but is not limited to, about 10% by weight to about 90% by weight of the core layer 600, e.g., about 20% by weight to about 80% by weight or about 30% by weight to about 70% by weight or about 40% by weight to about 60% by weight based on the total weight of the core layer 600.

In some examples, the exact amount of reinforcing materials, e.g., reinforcing fibers, present in the core layer 600 may vary. For example, the reinforcing material or fiber content in the core layer 600 may be greater than 0% by weight to about 90% by weight, e.g., about 1% to about 80% by weight of the core layer 600, more particularly from about 2% to about 80%, by weight of the core layer 600 or about 20% by weight to about 80% by weight of the core layer 600. The particular size and/or orientation of the hydrophilic fibers used may depend, at least in part, on the polymer material used and/or the desired properties of the resulting prepreg or core. Suitable additional types of reinforcing materials include but are not limited to particles, powder, fibers and the like. Where reinforcing fibers are present in the core 600, the reinforcing fibers may comprise one or more of glass fibers, polymeric fibers, polymeric bicomponent fibers, carbon fibers, graphite fibers, synthetic organic fibers, particularly high modulus organic fibers such as, for example, para- and meta-aramid fibers, nylon fibers, polyester fibers, or any of the high melt flow index resins described herein that are suitable for use as fibers, natural fibers such as hemp, sisal, jute, flax, coir, and kenaf, mineral fibers such as basalt, mineral wool (e.g., rock or slag wool), wollastonite, alumina, silica, and the like, or mixtures thereof, metal fibers, metalized natural and/or synthetic fibers, ceramic fibers, yarn fibers, or mixtures thereof, hydrophilic fibers, hydrophobic fibers of other types of fibers. In one non-limiting illustration, reinforcing fibers dispersed within a thermoplastic material to provide a prepreg or core generally have a diameter of greater than about 5 microns, more particularly from about 5 microns to about 22 microns, and a length of from about 5 mm to about 200 mm, more particularly, the hydrophilic fiber diameter may be from about 3 nanometers to about 22 microns and the fiber length may be from about 5 mm to about 75 mm.

In some embodiments, core layer 600 can be used, e.g., is compatible, with an adhesive layer. Referring to FIG. 6B, an adhesive layer 610 is shown as being present on one surface of the core layer 600. The adhesive layer 610 may comprise one or more aqueous adhesives, non-aqueous adhesives and/or mixtures of aqueous adhesives and non-aqueous adhesive can also be used. If desired, the adhesive layer 610 can be used to bond a skin layer 620 to the core layer 600 (see FIG. 6C), though if desired the skin layer 620 can be placed directly in contact with the core 600 without any adhesive layer (or other layer) between the skin 620 and the core 600. In some instances, a blend of different adhesives may also be used. If desired, individual adhesive strips can also be used.

In certain examples, the skin layer 620 may comprise a film (e.g., thermoplastic film or elastomeric film), a frim, a scrim (e.g., fiber based scrim or a scrim comprising hydrophilic fibers such as cellulose based fibers), a foil, a woven fabric, a non-woven fabric or be present as an inorganic coating, an organic coating, or a thermoset coating disposed on the prepreg or core 600. In other instances, the skin layer 620 may comprise a limiting oxygen index greater than about 22, as measured per ISO 4589 dated 1996. Where a thermoplastic film is present as (or as part of) the skin layer 620, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin layer 620, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin layer 620, the coating may comprise at least one of unsaturated polyurethanes, vinyl esters, phenolics and epoxies. Where an inorganic coating is present as (or as part of) the skin layer 620, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 620, the non-woven fabric may comprise a thermoplastic material, a thermal setting binder, inorganic fibers, metal fibers, metallized inorganic fibers and metallized synthetic fibers. If desired, the skin layer 620 may comprise an expandable graphite material, a flame retardant material, cellulose fibers or hydrophilic fibers.

In certain configuration, a second skin layer 630 can be present on an opposite surface of the core 600 as shown in FIG. 6D. An optional adhesive layer (not shown) can be present between the core 600 and the skin layer 630 if desired. In some instances, the skin layer 630 may comprise a film (e.g., thermoplastic film or elastomeric film), a frim, a scrim (e.g., fiber based scrim or a scrim comprising hydrophilic fibers such as cellulose based fibers), a foil, a woven fabric, a non-woven fabric or be present as an inorganic coating, an organic coating, or a thermoset coating disposed on the prepreg or core 600. In other instances, the skin layer 630 may comprise a limiting oxygen index greater than about 22, as measured per ISO 4589 dated 1996. Where a thermoplastic film is present as (or as part of) the skin layer 630, the thermoplastic film may comprise at least one of poly(ether imide), poly(ether ketone), poly(ether-ether ketone), poly(phenylene sulfide), poly(arylene sulfone), poly(ether sulfone), poly(amide-imide), poly(1,4-phenylene), polycarbonate, nylon, and silicone. Where a fiber based scrim is present as (or as part of) the skin layer 630, the fiber based scrim may comprise at least one of glass fibers, aramid fibers, graphite fibers, carbon fibers, inorganic mineral fibers, metal fibers, metalized synthetic fibers, and metalized inorganic fibers. Where a thermoset coating is present as (or as part of) the skin layer 630, the coating may comprise at least one of unsaturated polyurethanes, vinyl esters, phenolics and epoxies. Where an inorganic coating is present as (or as part of) the skin layer 630, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer 630, the non-woven fabric may comprise a thermoplastic material, a thermal setting binder, inorganic fibers, metal fibers, metallized inorganic fibers and metallized synthetic fibers. If desired, the skin layer 630 may comprise an expandable graphite material, a flame retardant material, cellulose fibers or hydrophilic fibers.

In other configurations, a decorative layer 650 can be present on one or both skin layers 620, 630. Referring to FIG. 6E, a decorative layer 650 is shown as being disposed on the skin layer 620. An optional adhesive layer (not shown) may be present between the decorative layer 650 and the skin layer 620. The decorative layer 650 can be a thermoplastic film of polyvinyl chloride, polyolefins, thermoplastic polyesters, thermoplastic elastomers, or the like. The decorative layer 650 can be a multi-layered structure that includes a foam core formed from, e.g., polypropylene, polyethylene, polyvinyl chloride, polyurethane, and the like. A fabric may be bonded to the foam core, such as woven fabrics made from natural and synthetic fibers, organic fiber non-woven fabric after needle punching or the like, raised fabric, knitted goods, flocked fabric, or other such materials. The fabric may also be bonded to the foam core with a thermoplastic adhesive, including pressure sensitive adhesives and hot melt adhesives, such as polyamides, modified polyolefins, urethanes and polyolefins. The decorative layer 650 can be produced using spunbond, thermal bonded, spun lace, melt-blown, wet-laid, and/or dry-laid processes. In some configurations, the decorative layer 650 can comprise an open cell structure or a closed cell structure.

In certain embodiments, two or more core layers can be stacked on top of each other to increase the overall thickness of the core. If desired, formed core layers can be stacked and then subjected to a hot press device to couple the core layers to each other. The resulting core layer can then be pressed using a suitable pressure to a desired thickness. Where stacks of core layers are used, the stack may comprise any of those materials, e.g., adhesive layers, skin layers, decorative layers, etc. as shown in FIGS. 6B-6E.

In certain embodiments, the various core layers described herein may comprise other materials including additives, perfumes, scents, dyes, colorants, antioxidants or other material as desired. In some configurations, the prepreg or core may be a substantially halogen free or halogen free prepreg or core to meet the restrictions on hazardous substances requirements for certain applications. In other instances, the prepreg or core may comprise a halogenated flame retardant agent (which can be present in the flame retardant material or may be added in addition to the flame retardant material) such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the prepregs and cores may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant where present may be present in about 0.1 weight percent to about 15 weight percent (based on the weight of the prepreg or core), more particularly about 1 weight percent to about 13 weight percent, e.g., about 5 weight percent to about 13 weight percent. If desired, two different halogenated flame retardants may be added to the prepregs or core. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the prepregs may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the prepreg or core), more particularly about 1 weight percent to about 13 weight percent, e.g., about 5 weight percent to about 13 weight percent based on the weight of the prepreg or core. If desired, two different substantially halogen free flame retardants may be added to the prepregs or cores. In certain instances, the prepregs or cores described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants (exclusive of any compounded flame retardant material) present may be about 0.1 weight percent to about 20 weight percent (based on the weight of the prepreg or core), more particularly about 1 weight percent to about 15 weight percent, e.g., about 2 weight percent to about 14 weight percent based on the weight of the prepreg or core. The flame retardant agents used in the prepregs or cores described herein can be added to the mixture comprising the thermoplastic material and fibers (prior to disposal of the mixture on a wire screen or other processing component) or can be added after the prepreg or core is formed.

In other instances, the prepreg or core may comprise one or more acid scavengers. Illustrative acid scavengers include, but are not limited to, metal stearates and metal oxides, e.g., calcium stearate, zinc stearate, zinc oxide, calcium lactate or dihydrotalcite. These or other suitable acid scavengers can be used to deter discoloration of the prepregs and cores described herein. Alternatively, when discoloration is desired, the prepregs or core can be free of any acid scavengers, e.g., free or substantially free of a metal stearate or a metal oxide such as, for example, calcium stearate, zinc stearate, zinc oxide, or calcium lactate.

In some instances, a phenolic antioxidant may be present and used to manipulate the color of the composite article. For example, a thermoplastic composite article may comprise a porous core comprising reinforcing fibers and a thermoplastic material, wherein the porous core further comprises a metal hydroxide flame retardant and an antioxidant, wherein the porous core comprises a web formed from the reinforcing fibers held in place by the thermoplastic material, and wherein the antioxidant in the porous core comprising the metal hydroxide flame retardant, when exposed to oxidizing agent, changes color from a first color to a second color and when the oxidizing agent is removed changes color from the second color to the first color. Since the reaction where the phenolic antioxidant changes color can be reversed, the color can be favored or deterred depending on the particular environmental conditions present.

In some configurations, the prepreg or core layer may comprise other materials such as lofting agents, expandable microspheres, expandable graphite materials, hydroxides such as aluminum hydroxide or magnesium hydroxide or other materials. For example, lofting agents can reside in the core layer and may be present in a non-covalently bonded manner or a covalently bonded manner. Application of heat or other perturbations can act to increase the volume of the lofting agent which in turn increases the overall thickness of the layer, e.g., the layer increases as the size of the lofting agent increases and/or additional air becomes trapped in the layer. In addition, some lofting can be achieved by heating the prepreg or core layer even where no added lofting agent is present. As noted herein, the hot press device can be used to press the heated web to a desired thickness. The cool press device can be used to maintain that thickness while the web cools. Post-processing of the cooled web can result in lofting or an increase in thickness of the prepreg or core layer. By maintaining the pressed thickness of the prepreg or core layer during cooling, enhanced lofting capacity can be present in the prepreg or core layers.

In certain embodiments, the areal density of the prepreg or core of any produced LWRT articles can range from about 300 grams per square meter (gsm) to about 4000 gsm, although the areal density may be less than 300 gsm or greater than 4000 gsm depending on the specific application needs. In some examples, the overall thickness of the prepreg, core or LWRT may be about 100 microns up to about 10 mm in a pre-lofted state. As noted herein, lofting can increase the overall thickness of the core layer, e.g., to about 35 mm or less post lofting, 20 mm or less post lofting, greater than 3 mm pre-lofted or greater than 6 mm pre-lofted. In some instances, the pre-lofted thickness may be between about 1 mm and about 10 mm, and the post-lofted thickness may be between about 5 mm and about 30 mm.

In producing the prepregs and cores described herein, it may be desirable to use a wet-laid process and additional materials. For example, a liquid or fluid medium comprising dispersed material, e.g., thermoplastic material and one or more types of reinforcing materials such as fibers, etc., optionally with any one or more additives described herein (e.g., other flame retardant agents), may be stirred or agitated in the presence of a gas, e.g., air or other gas. The dispersion may then be laid onto a moving support, e.g., a wire screen or other support material, to provide a substantially uniform distribution of the materials in the laid down material. To increase material dispersion and/or uniformity, the stirred dispersion may comprise one or more active agents, e.g., anionic, cationic, or non-ionic such as, for example, those sold under the name ACE liquid by Industrial Soaps Ltd., that sold as TEXOFOR® FN 15 material, by Glover Chemicals Ltd., and those sold as AMINE Fb 19 material by Float-Ore Ltd. These agents can assist in dispersal of air in the liquid dispersion. The components can be added to a mixing tank, flotation cell or other suitable devices in the presence of air to provide the dispersion. While an aqueous dispersion is desirably used, one or more non-aqueous fluids may also be present to assist in dispersion, alter the viscosity of the fluid or otherwise impart a desired physical or chemical property to the dispersion or the prepreg, core or article.

In certain instances, after the dispersion has been mixed for a sufficient period, the fluid with the suspended materials can be disposed onto a screen, moving wire or other suitable support structure to provide a web of laid down material. Suction or reduced pressure may be provided to the web to remove any liquid from laid down material to leave behind the thermoplastic material, and any other materials that are present, e.g., fibers, additives, etc. The resulting web can be dried and optionally consolidated or pressed to a desired thickness prior to fully forming it to provide a desired prepreg or core. While wet laid processes may be used, depending on the nature of the thermoplastic material and reinforcing materials, it may be desirable to instead use an air laid process, a dry blend process, a carding and needle process, or other known process that are employed for making non-woven products. In some instances, flame retardant materials, additional fibers or other materials can be sprayed onto the surface of the prepreg or core after the prepreg or core has hardened to some degree by passing the board underneath a plurality of coating jets that are configured to spray the materials at about a ninety degree angle to the prepreg or core surface. In addition, one or more skins, adhesive layers, decorative layers, etc. may be added to the formed core to provide an article. As noted herein, these additional layers can be added prior to heating or pressing or after heating and pressing has occurred.

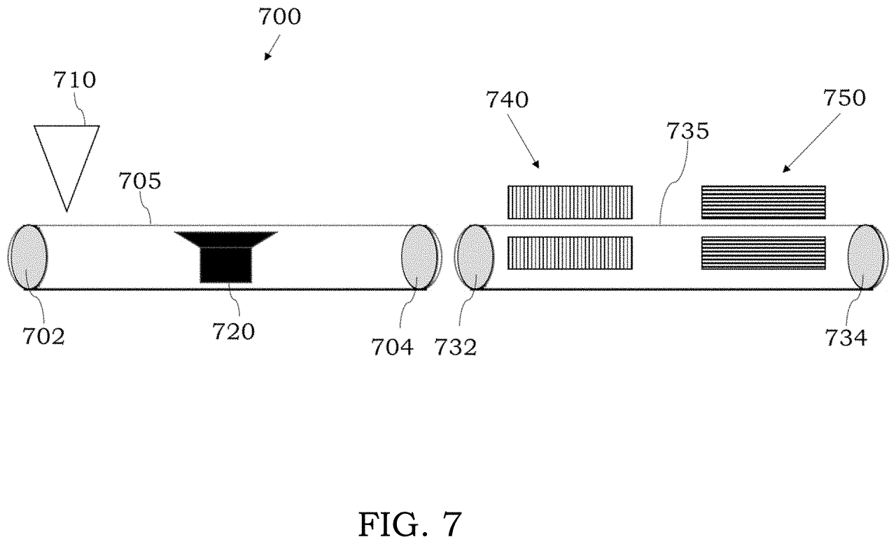

In certain embodiments, the cores, prepreg and LWRT articles described herein can be produced using an inline process and/or an inline system. An illustration of an inline system is shown in FIG. 7. The system 700 comprises a head box 710 that can be used to mix the materials and deposit a liquid comprising thermoplastic material (TP) and reinforcing materials (RM) on a moving support 705. The moving support 705 is moved using pulleys or rollers 702, 704 which can be coupled to a motor. A vacuum device 720 can be present to remove liquid, but not the TP or RM, from the deposited materials on the moving support 705 to form a web. The web can be permitted to solidify or dried for at least some period before being provided to a first press device 740. A moving belt 735 can receive the dried web from the moving support 705. The gap between the moving support 705 and the belt can be small so the dried web does not fall through. The first press device 740 can be used to heat and press the dried web using a first temperature, e.g., 170-240 degrees Celsius, and a first pressure by moving the two plated closer to each other. The exact time used to heat the web in the first press device 740 may vary from about 2 seconds to about 1 minute depending on the overall thickness of the dried web. The first press device 740 may also provide a first pressure to the heated web in the first press device 740 to compress it to a desired thickness. During pressing using the first press device 740, movement of the belt 735 may stop if desired. If desired, a release liner can be placed between the plates of the first press device 740 and the web to prevent the web from sticking to the plates. The exact pressure applied by the first press device 740 can vary from about 2 bar to about 30 bar, e.g., about 3 bar to about 15 bar. Once the web is heated to the first temperature, pressure can be removed and the heated web can then be provided between the plates of the second press device 750 to cool the web. The second press device 750 can press the heated web using a second pressure that is the same as or less than the first pressure provided by the first pressure device 740. For example, the exact pressure applied by the second press device 750 can vary from about 2 bar to about 30 bar, e.g., about 3 bar to about 15 bar. A second temperature provided by the second press device 750 is typically lower than a melting temperature of the TP in the web. In some instances, the second temperature can be about 0 degrees Celsius to about 50 degrees Celsius, e.g., 5 degrees Celsius to 45 degrees Celsius. Once the web is cooled, it can move along the moving belt 735 and be collected, stacked or palletized.

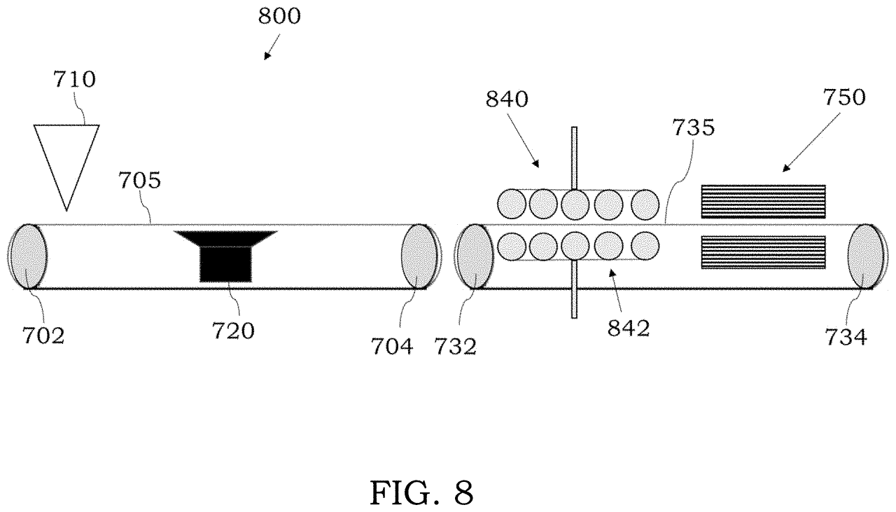

In some embodiments, an inline system may comprise one or more rollers or roller sets that can be used to heat the web and/or apply pressure to the web. An illustration is shown in FIG. 8, where a system 800 comprises a roller set comprising upper rollers 840 and lower rollers 842. If desired, the rollers or pulleys 732 and 734 can be omitted and the rollers 840 and 842 can be used to drive the moving belt 735. The height of each roller in the rollers sets 840, 842 can be adjusted independently if desired or may be adjusted in unison. The rollers 840, 842 are typically held at the same temperature though they may be held at different temperatures if desired. The exact number of rollers present may vary from about two to ten or more depending on the dimensions of the web and/or the speed of the moving belt. When rollers are used, the moving belt 735 can continue to move during pressing and heating of the web. The rollers 840, 842 are typically used as a first press device to heat and press the web to a desired thickness and permit wet out of the reinforcing materials by the thermoplastic material. The exact time used to heat the web in the rollers 840, 842 may vary from about 2 seconds to about 1 minute depending on the overall thickness of the dried web. The temperature of the rollers 840, 842 is typically above the melting temperature of the TP material, e.g., 170 degrees Celsius to 240 degrees Celsius. The rollers 840, 842 may also provide a first pressure to the heated web to compress it to a desired thickness. The exact pressure applied by the rollers 840, 842 can vary from about 2 bar to about 30 bar, e.g., about 3 bar to about 15 bar. Once the web is heated and pressed using the rollers 840, 842 the web can be provided to a second press device 750 which comprises an upper plate and a lower plate. The second press device 750 can press the heated web received from the rollers 840, 842 using a second pressure that is the same as or less than the first pressure provided by the rollers 840, 842. For example, the exact pressure applied by the second press device 750 can vary from about 2 bar to about 30 bar, e.g., about 3 bar to about 15 bar. A second temperature provided by the second press device 750 is typically lower than a melting temperature of the TP in the web. In some instances, the second temperature can be about 0 degrees Celsius to about 50 degrees Celsius, e.g., 5 degrees Celsius to 45 degrees Celsius. Once the web is cooled, it can move along the moving belt 735 and be collected, stacked or palletized.

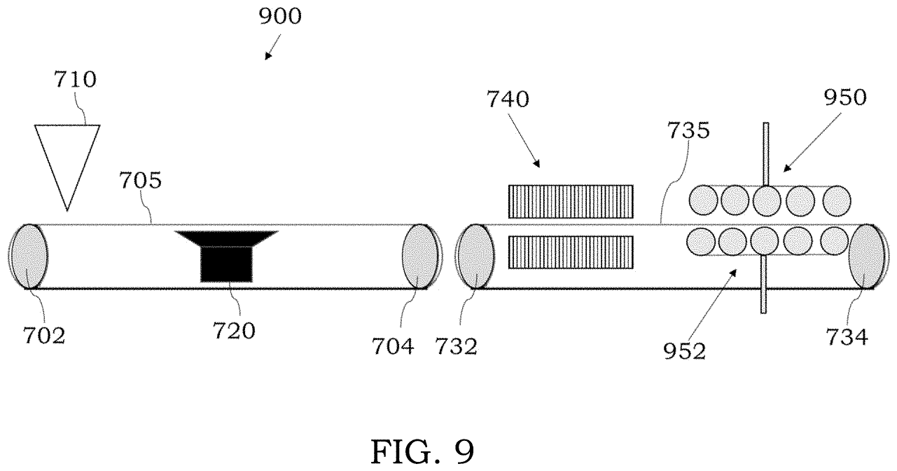

In certain instances, rollers or rollers sets can instead be used as a cool press device. Referring to FIG. 9, a system 900 comprises a roller set comprising upper rollers 950 and lower rollers 952. The rollers 950, 952 can be used to cool the heated web from the first press device 740 and apply a suitable pressure to the heated web to maintain its thickness during cooling. For example, the rollers 950, 952 can be used to apply a second pressure that is the same as or less than the first pressure provided by the first press device 740. In some instances, the exact pressure applied by the rollers 950, 952 can vary from about 2 bar to about 30 bar, e.g., about 3 bar to about 15 bar. A second temperature provided by the rollers 950, 952 is typically lower than a melting temperature of the TP in the web. In some instances, the second temperature can be about 0 degrees Celsius to about 50 degrees Celsius, e.g., 5 degrees Celsius to 45 degrees Celsius. Once the web is cooled using the rollers 950, 952, it can move along the moving belt 735 and be collected, stacked or palletized.

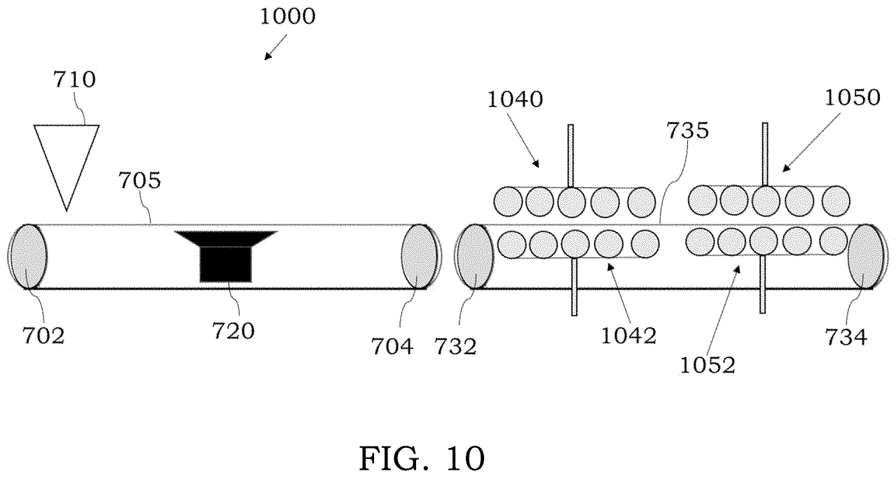

In other configurations, rollers can be used as both the first press device and the second press device. For example and referring to FIG. 10, rollers 1040, 1042 form a first press device and rollers 1050, 1052 form a second press device. The temperature of the rollers 1040, 1042 is typically above the melting temperature of the TP material, e.g., 170 degrees Celsius to 240 degrees Celsius. The rollers 1040, 1042 may also provide a first pressure to the heated web to compress it to a desired thickness. The exact pressure applied by the rollers 1040, 1042 can vary from about 2 bar to about 30 bar, e.g., about 3 bar to about 15 bar. Once the web is heated and pressed using the rollers 1040, 1042 the web can be provided to the rollers 1050, 1052 to cool and press the heated web. In certain examples, the exact pressure applied by the rollers 1050, 1052 can vary from about 2 bar to about 30 bar, e.g., about 3 bar to about 15 bar. A second temperature provided by the rollers 1050, 1052 is typically lower than a melting temperature of the TP in the web. In some instances, the second temperature can be about 0 degrees Celsius to about 50 degrees Celsius, e.g., 5 degrees Celsius to 45 degrees Celsius. Once the web is cooled using the rollers 1050, 1052, it can move along the moving belt 735 and be collected, stacked or palletized.

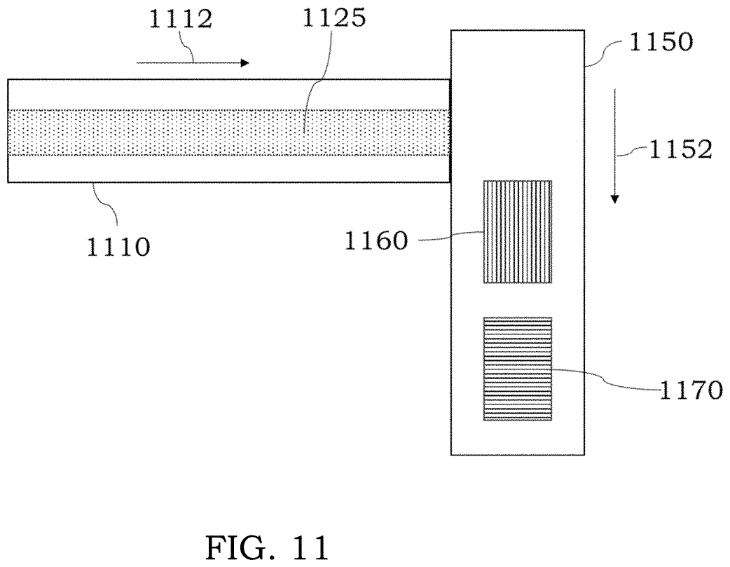

In certain embodiments, the press devices can be present in a different sub-system than the sub-system used to produce the web. One illustration is shown in FIG. 11, where a first subsystem 1110 is shown that comprises a moving support 1125 that moves in the general direction of arrow 1112. The moving support can receive a liquid comprising a thermoplastic material and reinforcing materials to form a web. The formed web can be dried and cut into individual sections using the subsystem 1110. Individual web sections can then be provided to a second subsystem 1150 with a moving belt or support that moves the individual web sections in the general direction shown by arrow 1152. The individual sections can be provided to a first press device 1160 to heat and press the formed web at a first temperature and first pressure as noted herein. The heated web section can then be provided to a second press 1170 to cool and press the heated web to maintain its thickness during cooling. The cooled web can then be discharged from the subsystem and collected, stacked or palletized. While plates are shown in the first press device 1160 and the second press device 1170, rollers, roller sets or other devices could instead be used to heat and cool the individual web sections received from the subsystem 1110.

The methods and systems described herein can be used to produce LWRT articles including automotive article, building materials, recreational vehicle articles and other articles where high mechanical properties and light weight properties are desired. Some of the many possible LWRT articles are described below.

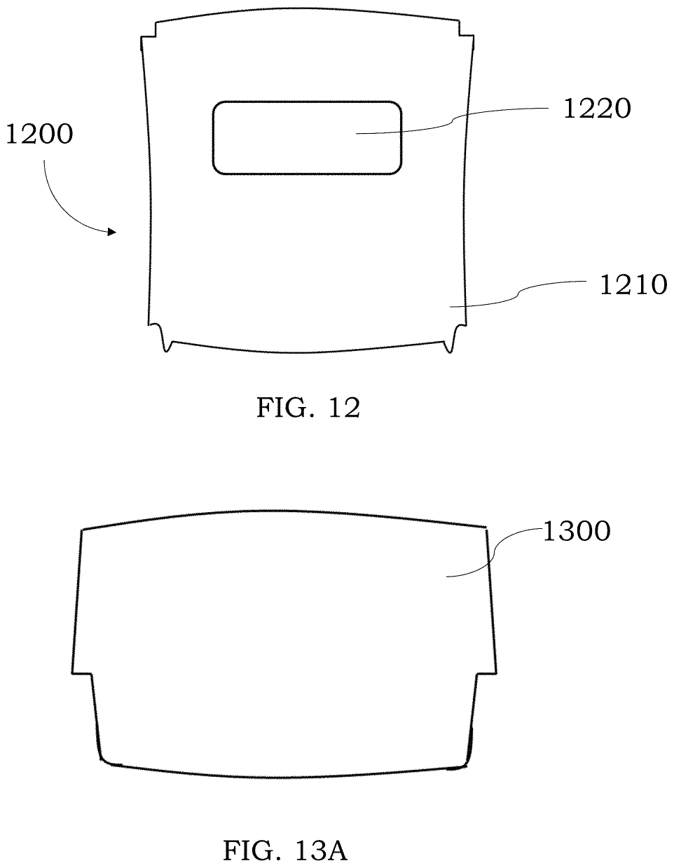

In certain configurations, the prepregs or cores described herein can be used to provide a vehicle headliner. Illustrative vehicles include, but are not limited to, automotive vehicles, trucks, trains, subways, recreational vehicles, aircraft, ships, submarines, space craft and other vehicles which can transport humans or cargo. In some instances, the headliner typically comprises at least one prepreg or core layer and a decorative layer, e.g., a decorative fabric, disposed on the core layer. The decorative layer, in addition to being aesthetically and/or visually pleasing, can also enhance sound absorption and may optionally include foam, insulation or other materials. An illustration of a top view of a headliner is shown in FIG. 12. The headliner 1200 comprises a body 1210 and an opening 1220, e.g., for a sunroof, moonroof, etc., though more than a single opening may be present if desired. The body of the headliner 1210 can be produced by initially heating and pressing a prepreg or core layer using a first press device and then cooling the heated prepreg or core layer under pressure. The cooled prepreg or core layer can then be moved to a press with matching male and female mold halves where the decorative fabric is put on and pressed with the desired mold to convert the article into a headliner. The opening 1220 may then be provided by trimming the headliner 1200. The “C” surface or roof side of the headliner typically consists of a PET non-woven scrim layer for handling purposes. The overall shape and geometry of the headliner 1200 may be selected based on the area of the vehicle which the headliner is to be coupled. For example, the length of the headliner can be sized and arranged so it spans from the front windshield to the rear windshield, and the width of the headliner can be sized and arranged so it spans from the left side of the vehicle to the right side of the vehicle.

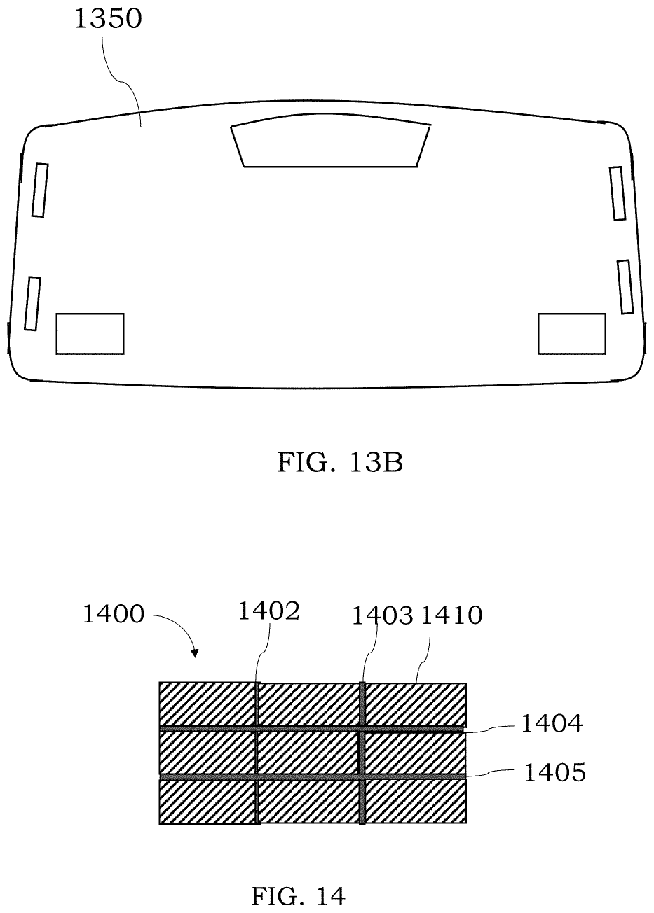

In certain instances, similar methods can be used to produce underbody shields and rear window trim pieces or parts from the prepreg or core layer that has been heated and pressed and cooled and pressed to maintain its thickness. An illustration of an underbody shield 1300 is shown in FIG. 13A, and an illustration of top view of a rear window trim 1350 is shown in FIG. 13B. The particular outer layers used in the underbody shield 1300 and the rear window trim 1350 may be different from the headliner. For example, the underbody shield may comprise a scrim or other outer layer to increase its durability and/or the acoustic characteristics. The inner surface of the underbody shield, e.g., which sits adjacent to the bottom of the engine may comprise one or more layer designed to absorb and/or retain automotive fluids such as motor oil, antifreeze, brake fluid or the like. While various openings are shown in the rear window trim 1350, the positions and geometries of these openings may vary. In addition, typical rear window trim decorative material may comprise a non-backed PET or PP carpet.

In certain examples, the prepregs or core layers produced as described herein can be used in composite articles configured for interior use in recreational vehicle panels, wall panels, building panels, roofs, flooring or other applications. As noted herein, the composite articles are generally used in an as-produced state and are not molded. In certain examples, the articles described herein can be configured as a ceiling tile. Referring to FIG. 14, a grid of ceiling tiles 1400 is shown that comprises support structures 1402, 1403, 1404 and 1405 with a plurality of ceiling tiles, such as tile 1410, laid into the grid formed by the support structures. In some examples, the ceiling tile comprises a porous core layer comprising a web of open celled structures comprising a random arrangement of a plurality of reinforcing fibers held together by a thermoplastic material. In some examples, the ceiling tile 1410 may comprise a porous decorative layer disposed on the open cell skin, e.g., a fabric, cloth, or other layers.

In certain examples, a LWRT article can be configured as a cubicle panel. Referring to FIG. 15, a top view of a cubicle 1500 comprising side panels 1510, 1530 and center panel 1520 are shown. Any one or more of the panels 1510-1530 may comprise one of the porous core layers produced as described herein. The cubicle panel may also comprise one or more skin layers. In some examples, the cubicle wall panel is sized and arranged to couple to another cubicle wall panel and comprises a porous core layer comprising a web of open celled structures comprising a random arrangement of a plurality of reinforcing fibers held together by a thermoplastic material.

In certain embodiments, a LWRT article can be configured as a structural panel. The structural panel can be used, for example, as sub-flooring, wall sheathing, roof sheathing, as structural support for cabinets, countertops and the like, as stair treads, as a replacement for plywood and other applications. If desired, the structural panel can be coupled to another substrate such as, for example, plywood, oriented strand board or other building panels commonly used in residential and commercial settings. Referring to FIG. 16A, a top view of a structural panel 1610 is shown. The panel 1610 may comprise any one of the core layers produced as described herein. If desired, two or more structural panels can be sandwiched with a skin facing into the interior of the room and another skin of the other structural panel facing outward away from the interior of the room. In some instances, the structural panel may also comprise a structural substrate 1620 as shown in FIG. 16B. For example, a structural panel may comprise a porous core layer comprising a web of open celled structures comprising a random arrangement of a plurality of reinforcing fibers held together by a thermoplastic material. The exact nature of the structural substrate 1620 may vary and includes, but is not limited to, plywood, gypsum board, wood planks, wood tiles, cement board, oriented strand board, polymeric or vinyl or plastic panels and the like. In some examples, the structural substrate comprises a plywood panel, a gypsum board, a wood tile, a ceramic tile, a metal tile, a wood panel, a concrete panel, a concrete board or a brick. If desired, the structural panel may further comprise a second structural panel coupled to a skin layer of the first structural panel, wherein the second structural panel is a porous structural panel.

In certain instances, a LWRT article can be configured as a wall board or wall panel. The wall panel can be used, for example, to cover studs or structural members in a building, to cover ceiling joists or trusses and the like. If desired, the wall panel can be coupled to another substrate such as, for example, tile, wood paneling, gypsum, concrete backer board, or other wall panel substrates commonly used in residential and commercial settings. Referring to FIG. 17, a side view of a wall panel 1700 is shown. The panel 1700 may comprise one of the porous core layers produced as described herein. As noted herein, the panel may also comprise one or more skins on its surface. If desired, two or more wall panels can be sandwiched with one open cell skin facing into the interior of the room and the open cell skin of the other wall panel facing outward away from the interior of the room. The wall panel 1700 may also comprise at least one skin 1720 coupled to a first surface of the porous core layer 1710. While not shown, a second skin may be placed on a second surface of the core layer 1710. An optional wall substrate can be coupled to a second surface of the porous core layer 1710 and configured to support the porous core layer 1710 when the wall panel 1700 is coupled to a wall surface. In certain configurations, the wall panel 1700 further comprises a porous decorative layer disposed on the skin 1720. In certain embodiments, a second wall panel can be coupled to the skin 1720, wherein the second wall panel is a porous wall panel.

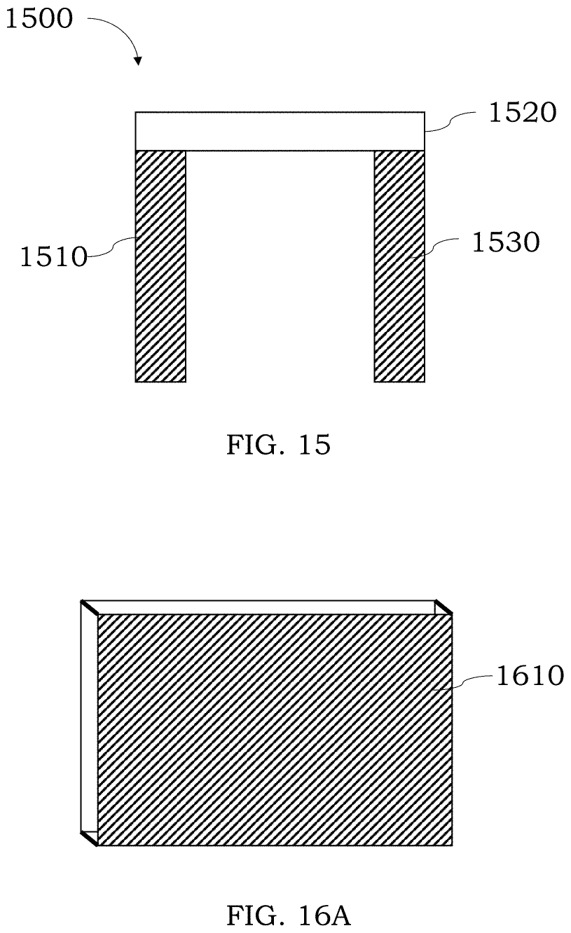

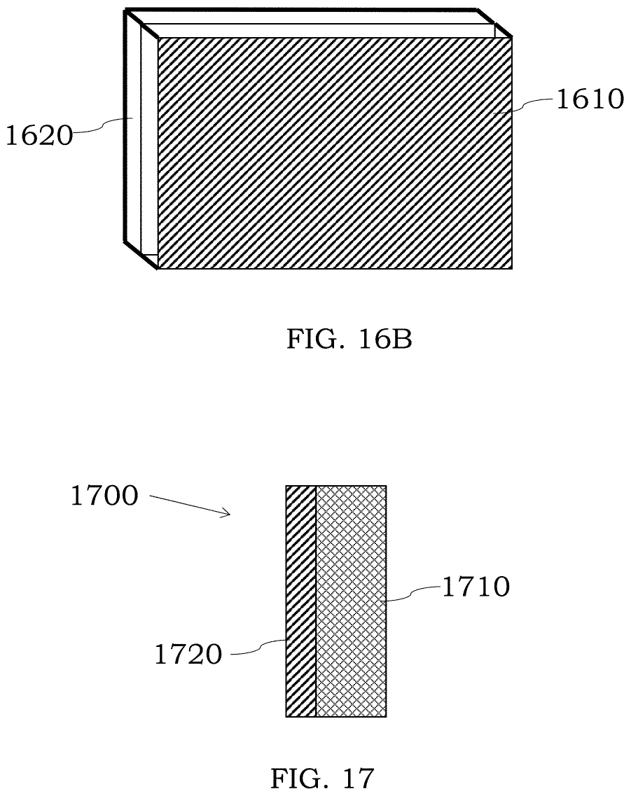

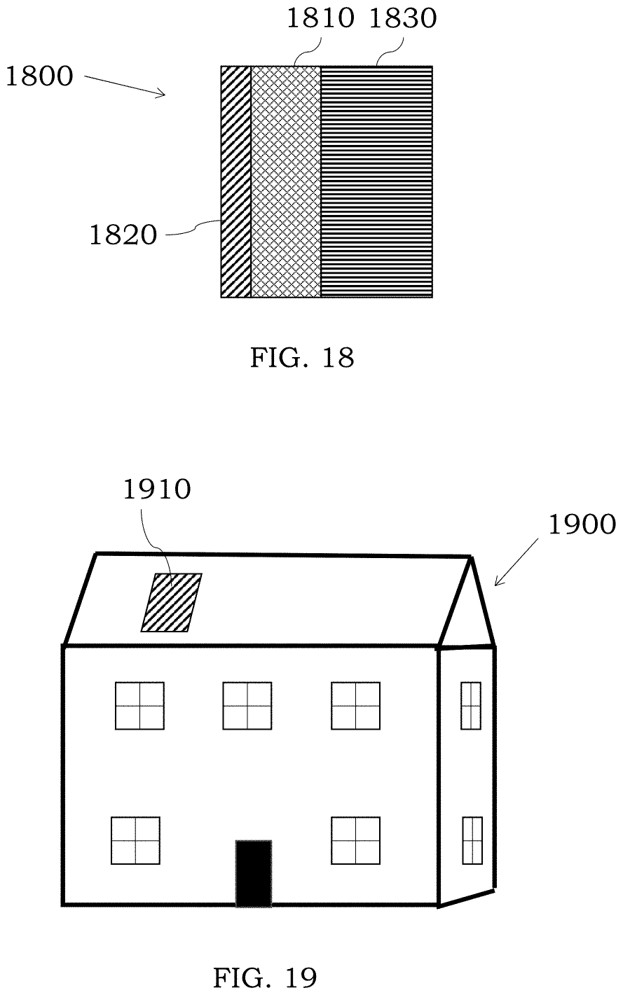

In certain instances, a LWRT can be configured as a siding panel to be attached to a building such as a residential home or a commercial building. The siding panel can be used, for example, to cover house wrap, sheathing or other materials commonly used on outer surfaces of a building. If desired, the siding panel can be coupled to another substrate such as, for example, vinyl, concrete boards, wood siding, bricks or other substrates commonly placed on the outside of buildings. Referring to FIG. 18, a side view of a siding panel 1800 is shown. The panel 1800 may comprise any one of the core layers or articles produced as described herein, e.g., core layer 1810 and a skin 1820. If desired, two or more siding panels can be sandwiched with one open cell skin facing into the interior of the building and the open cell skin of the other wall panel facing outward away from the interior of the building. A substrate 1830 can be configured with many different materials including, but not limited to vinyl, wood, brick, concrete, etc. For example, a vinyl substrate can be coupled to a first surface of the flame retardant and noise reducing layer, and the siding can be configured to couple to a non-horizontal surface of a building to retain the siding panel to the non-horizontal surface of the building. In some instances, the siding panel further comprises a weather barrier, e.g., house wrap, a membrane, etc. coupled to a second surface of the flame retardant and noise reducing layer. In some embodiments, the substrate comprises a nailing flange to permit coupling of the siding to the side of the building. In some examples, the flame retardant agent is homogeneously dispersed in the porous core layer. In some examples, the siding panel may further comprise a second siding panel and can be coupled to a second substrate. In some cases, a butt joint, overlapping joint, etc. may exist where the two siding panels can horizontally lock into each other.

In certain instances, a LWRT article can be configured as a roofing panel to be attached to a building such as a residential home or a commercial building. The roofing panel can be used, for example, to cover an attic space, attach to roof trusses or cover a flat roof as commonly present in commercial buildings. If desired, the roofing panel can be coupled to another substrate such as, for example, oriented strand board, plywood, or even solar cells that attach to a roof and function to cover the roof. Referring to FIG. 19, a perspective view of a roofing panel 1910 attached to a house 1900 is shown. The roofing panel 1910 may comprise any one of the core layers or articles produced as described herein. If desired, two or more roofing panels can be sandwiched or otherwise used together. The roofing panel may also comprise a roofing substrate coupled to a first surface of a core layer and can be coupled to a roof of a building to retain the roofing panel to the roof. In some examples, the roofing panel may comprise or be used with a weather barrier, e.g., a membrane, house wrap, tar paper, plastic film, etc. In other instances, the roofing substrate comprises a cellulose-based material. In certain instances, the roofing panel comprises a second roofing panel or can be overlapped with, or coupled to, a second roofing panel to prevent moisture from entering into the house 1900.

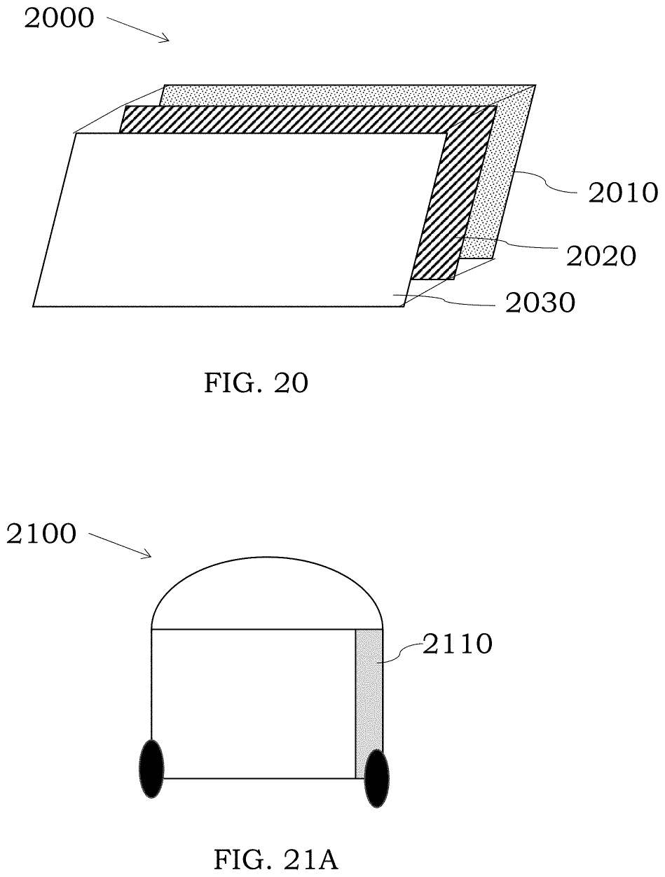

In certain configurations, a LWRT article can be configured as a roofing shingle to be attached to a building such as a residential home or a commercial building to absorb sound and to provide flame retardancy. The roofing shingle can be used, for example, to cover a roof commonly present in residential and commercial buildings. If desired, the roofing shingle can be coupled to another substrate such as, for example, asphalt, ceramic, clay tile, aluminum, copper, wood such as cedar and other materials commonly found or used as roofing shingles Referring to FIG. 20, an exploded view of a roofing shingle 2000 is shown. The roofing shingle 2000 may comprise any one of the core layers or articles described herein. If desired, two or more roofing shingles can be sandwiched. In some examples, the roofing shingle 2000 may comprise a core layer 2010. If desired, a weatherproof roofing shingle substrate 2030 can be coupled to a first surface of the article and configured to couple to a roofing panel of a building to provide a weatherproof and flame retardant roofing panel. In certain instances, a weather barrier can be coupled to a roofing shingle. In other examples, the roofing shingle comprises asphalt. An intermediate layer 2020, e.g., a skin, insulation or other materials, can be present between the outer layer 2030 and substrate 2010.

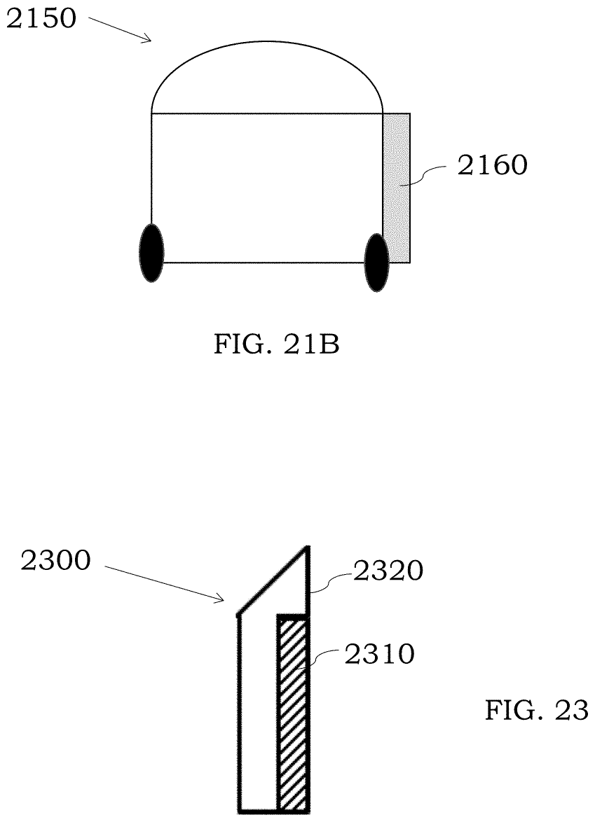

In certain configurations, any one or more of the core layers or articles described herein can be configured as an interior panel or wall of a recreational vehicle (RV) or an interior panel of an aircraft or aerospace vehicle, e.g., a rocket, satellite, shuttle or other airline or space vehicles. The panel or wall can be used, for example, to cover a skeleton structure on an interior side of the recreational or aerospace vehicle and may be coupled to foam or other insulation materials between the interior and exterior of the vehicle. In some examples, the core layer or article may be part of a sandwich structure formed from the core layer or article and other layers. If desired, the interior panel can be coupled to another substrate such as, for example, a fabric, plastic, tile, etc. Referring to FIG. 21A, a side view of a recreational vehicle 2100 is shown. The interior panel 2110 may comprise any one of the core layers or articles produced as described herein. If desired, two or more RV panels can be sandwiched or coupled together. In some examples, RV panel may comprise an interior wall substrate that is configured as a decorative layer such as a fabric, a plastic, tile, metal, wood or the like. In additional instances, the RV panel comprises a second RV interior panel which can be the same or different from the RV panel. If desired, the RV panel may comprise a third RV interior panel which may also be the same or different. While not shown, a similar interior panel can be present in aerospace applications/vehicles and may be placed against and/or coupled to an exterior skin such as a metal or metal alloy skin or structure, e.g., aluminum, magnesium, titanium, etc. or other exterior structure.

In certain configurations, any one or more of the core layers or articles described herein, can be configured as an exterior panel or wall of an aircraft vehicle, an aerospace vehicle or a recreational vehicle. The panel or wall can be used, for example, to cover a skeleton structure on an exterior side of the vehicle and may be coupled to foam or other insulation materials between the interior and exterior of the vehicle. In some examples, the core layer or article may be part of a sandwich structure formed from the core layer or article and other layers. If desired, the exterior panel can be coupled to another substrate such as, for example, a metal, a metal alloy, fiberglass, etc. Referring to FIG. 21B, a side view of a recreational vehicle 2150 is shown that comprises an exterior panel 2160, which can be configured as any one of the core layers or articles produced as described herein. If desired, two or more RV panels can be sandwiched with one open cell skin facing into the interior of the RV and the open cell skin of the other RV panel facing outward away from the interior of the RV. In certain configurations, the exterior wall substrate comprises glass fibers or is configured as a metal panel such as aluminum or other metal materials. In additional instances, the RV panel comprises a second RV exterior panel which can be the same or different from the RV panel. If desired, the RV panel may comprise a third RV exterior panel which may also be the same or different. While not shown, a similar exterior panel can be present in aerospace applications/vehicles and may be placed against and/or coupled to an interior skin or structure such as an interior metal or metal alloy skin, e.g., aluminum, magnesium, titanium, etc., or other interior structure.

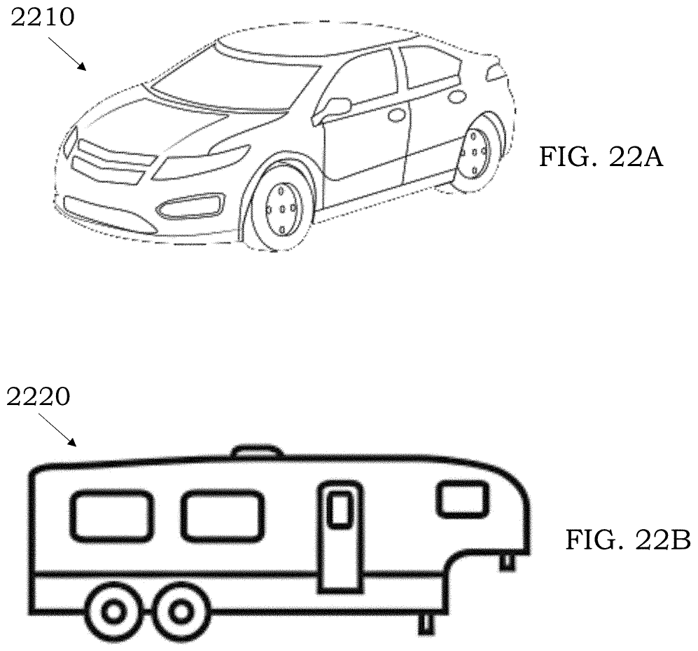

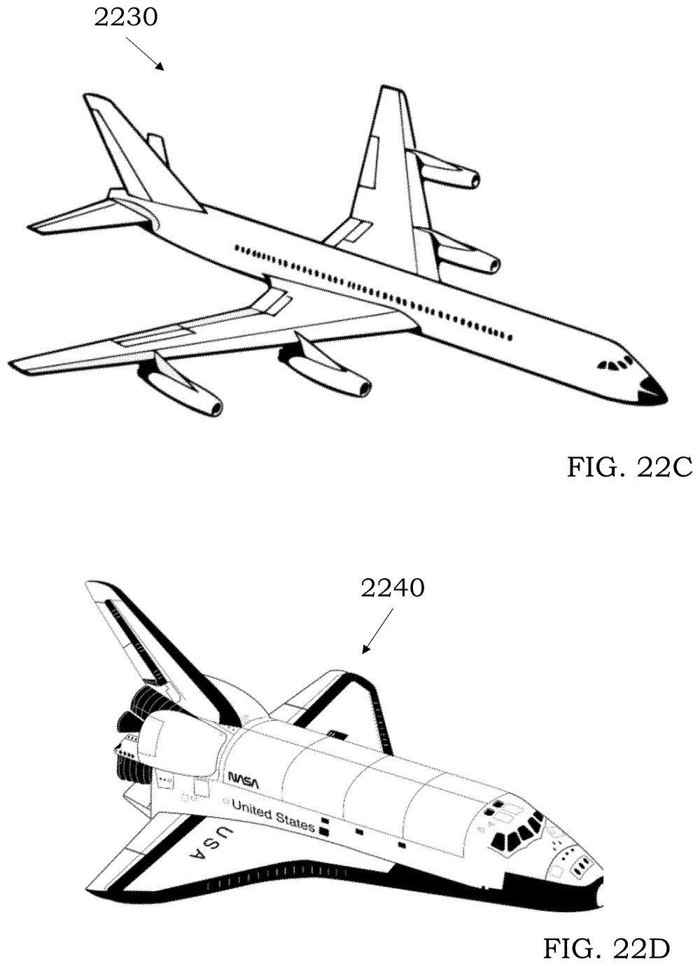

In certain examples, the core layers and LWRT articles described herein can be used in an automotive vehicle (FIG. 22A), a recreational vehicle (FIG. 22B), an airplane (FIG. 22C), a shuttle or a spacecraft (FIG. 22D), a rocket, a satellite, or other vehicles which comprise one or more wheels, an engine, a motor, a turbine, a rocket, a fuel cell, a battery, are solar powered, are powered by wind, are gas propelled or have a motive means which can be used to propel the vehicle. As shown in FIG. 22B, however, vehicles with cores layers and LWRT's as described herein may be towed behind or coupled to another vehicle if desired and may not have an independent motor or engine to propel them.

In some examples, similar constructs can be used as interior trim applications, e.g., RV interior trim, interior trim for building or for automotive applications. For example, an interior trim comprising a porous core layer comprising a web of open celled structures comprising a random arrangement of a plurality of reinforcing fibers held together by a thermoplastic material can be used in interior trim applications. The interior trim substrate can be coupled to other materials, such as, for example, wood, PVC, vinyl, plastic, leather or other materials. A side view illustration of a trim piece that can be used as baseboard trim is shown in FIG. 23. The trim piece 2300 comprises a trim substrate 2320. The trim piece 2300 may be nailed or otherwise attached to a stud or wallboard 2310 as desired. The substrate 2320 faces outward and is viewable within a room. The trim piece 2300 can be curved or may take two or three dimensional shapes as desired.

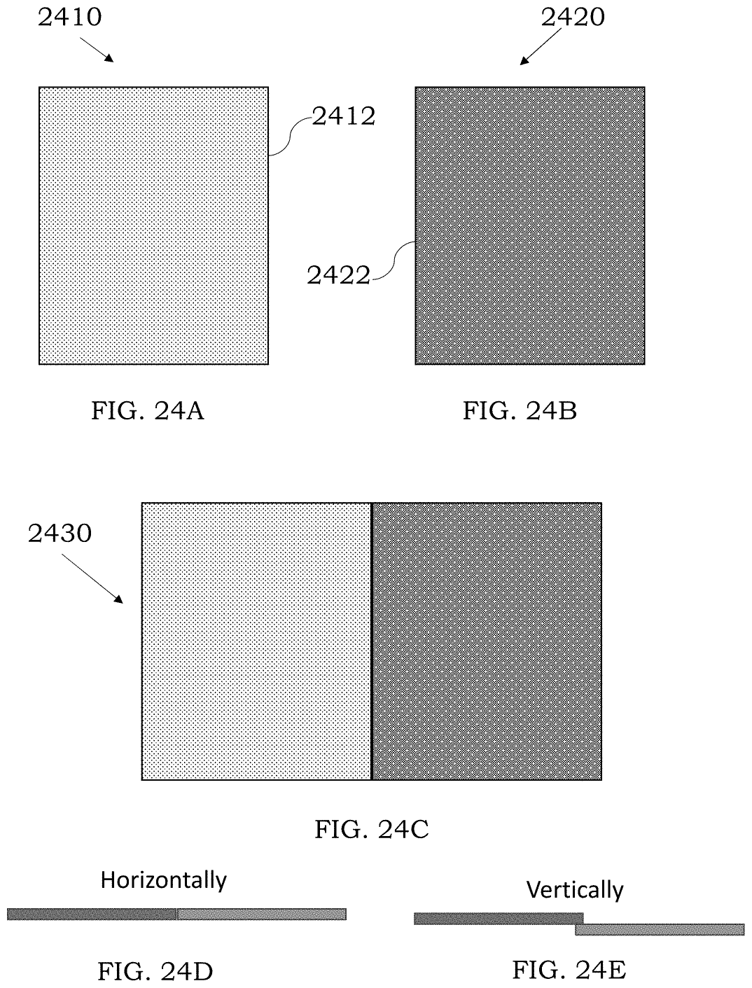

In certain embodiments, the methods and systems described herein can be used to edge couple two or more individual web sections to each other. An illustration is shown in FIG. 24A, 24B and 24C where a first core layer 2410 is edge coupled to a second core layer 2420 to form a LWRT article 2430. An edge 2412 and an edge 2422 can be placed adjacent to each other horizontally or vertically in a first press device. For example, the first press device can edge couple machine direction edges, cross direction edges or can couple a machine direction edge of one core layer to a cross direction edge of another core layer. The edges can be placed beside each other (FIG. 24D) or vertically overlap (FIG. 24E). The placed core layers 2410, 2420 can then be heated and pressed using a first press device. Heating and pressing of the core layers 2410, 2420 results in the two core layers coupling to each other at the edges. The resulting combined core layer 2430 can then be provided to a second press device to cool and press it and maintain its overall thickness while it is cooled. If desired, three or more core layers can be edge coupled to each other to provide a LWRT with the same or a variable basis weight across the surface of the edge coupled core layer.

In certain examples, using the methods and systems described herein, it can be possible to increase mechanical properties of LWRT articles particularly those where the core layer is 1500 gsm or below. For example, mechanical properties can increase 10% or more when the core layers are produced using the method described herein, e.g., when the core layers are subjected to the first and second press devices. In one instance, peak load in the machine direction (MD) or cross direction (CD) or both can increase by at least 5% (1200 core gsm, in MD for 5 seconds of hot pressing) at least 25% (1000 core gsm in MD for 5 seconds of hot pressing) or at least 35% (450 gsm in MD for 5 seconds of hot pressing). In another instance, stiffness in the machine direction or cross direction or both can increase by at least 5% (1200 core gsm in both MD and CD directions), at least 15% (1000 core gsm, in MD for 10 seconds of hot pressing) or at least 45% (450 core gsm, in CD for 5 seconds of hot pressing). In some examples, tensile strength can increase in the machine direction or cross direction or both can increase by at least 5% (1200 core gsm, MD for 10 seconds of hot pressing), at least 5% (1000 core gsm, CD for 5 seconds of hot pressing) or at least 5% (450 core gsm, in CD for 5 seconds of hot pressing). In some examples, modulus can increase in the machine direction or cross direction or both can increase by at least 1% (1200 core gsm in MD for 10 seconds of hot pressing), at least 5% (1000 core gsm in MD for 20 seconds of hot pressing) or at least 7.5% (450 core gsm, in CD for 5 seconds of hot pressing). These properties can be measured, for example, using one or more of ASTM D790 dated 2017 and ASTM D5034 dated 2009.

In certain embodiments, the density of the core layer of the LWRT article may vary from about 0.1 g/cm³ to about 1.5 g/cm³. In some configurations, the density can vary from about 0.1 g/cm³ to about 0.8 gm/cm³ or about 0.2 g/cm³ to about 0.7 g/cm³ or about 0. 3 g/cm³ to about 0.6 g/cm³ or about 0.3 g/cm³ to about 0.5 g/cm³. In other instances, the density may vary from about 0.6 g/cm³ to about 1.3 g/cm³ or about 0.7 g/cm³ to about 1.2 g/cm³ or about 0.8 g/cm³ to about 1.1 g/cm³ or about 0.8 g/cm³ to about 1.0 g/cm³. The exact density selected can depend on the intended and/or final use of the article that includes a core layer or LWRT article. For example, in aerospace applications it may be desirable to use a more dense board, e.g., one with a core layer having a density of about 0.6 g/cm³ to about 1.3 g/cm³, whereas certain automotive applications may use less dense core layers, e.g., core layers with a density of about 0. 3 g/cm³ to about 0.6 g/cm³.

In certain configurations, using the methods described herein reinforcing material or reinforcing fiber wet out can increase after post consolidation. An indirect measure of the increase in fiber wet out is a ratio of 1/post-consolidated thickness to 1/pre-consolidated thickness to, which is also referred to herein as a density ratio. For example, thickness of the core layer can decrease by 50% or more using the press devices described herein. The exact thickness change can depend, at least in part, on the basis weight of the core layers. As one non-limiting example, for a 1000 gsm core, as produced thickness can be about 3.5 mm and post-consolidated thickness can be about 1.1 mm. These values would provide a density ratio of (1/1.1)/(1/3.5)=3.2. In contrast, an unconsolidated board would have a density ratio of 1. In some embodiments described herein, the density ratio of the core layer is at least 1.5 or at least 2.0 or at least 2.25, at least 2.5, at least 2.75, at least 3.0 or at least 3.25. While not necessarily true in all cases, heavier core layers tend to have higher density ratios as the pre-consolidated thickness tends to be higher.

Certain specific configurations are described to illustrate further some of the novel and inventive aspects, embodiments, features and elements of the technology described herein.

### EXAMPLE 1

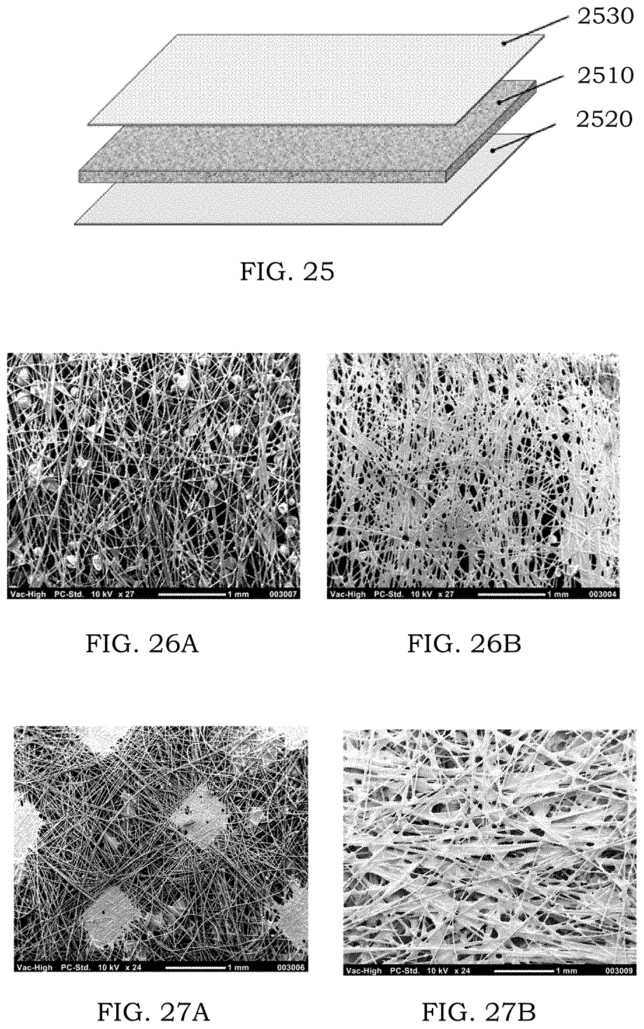

An LWRT core was manufactured using a wet-laid process. Polypropylene powder, chopped glass fiber and other additives were dispersed in water. The aqueous slurry was transferred onto a web forming section of a moving support. The resulting liquid was removed leaving a web. The web was drained and then heated to be above the melting point of the polypropylene resin. According to the end-use application, the LWRT core 2510 was then laminated with surface materials (non-woven scrim or woven frim 2530 on the top and a polymer film 2520 on the bottom) on both sides as shown in FIG. 25. Finally, the material was consolidated to produce a flat LWRT composite sheet. Materials with various basis weight (areal densities) can be produced by adjusting the manufacturing parameters.

Three samples with different basis weight (gsm or grams per square meter) were produced as shown in Table 1.

TABLE 1

| Sample | Core's basis weight (gsm) | Skin on top | Skin on bottom |
|---|---|---|---|
| A | 450 | 20 gsm scrim | 98 gsm film |
| B | 1000 | 20 gsm scrim | 70 gsm film |
| C | 1200 | 20 gsm scrim | 70 gsm film |

Each LWRT article was post-consolidated using a hot press and a cold press. The as-produced LWRT composite board was pressed in the hot press with a selected pressure and dwell time. In this example, the hot press was heated and maintained at 195 degrees Celsius and a pressure of 3.8 bar was applied to the LWRT board. Three dwell times in the hot press were investigated including five, ten and twenty seconds. After heating in the hot press, the board is transferred to the cold press to cool down, where the same pressure and dwell time are used as in the hot press. The cold press was used to maintain the thickness of the hot pressed board and prevent the occurrence of lofting while cooling. After consolidation, the board can be lofted and molded to the targeted thickness through the thermoforming process. For purposes of comparison, a control for each sample was directly lofted and molded to the targeted thickness without post consolidation using the hot press and the cold press. The post consolidation settings and targeted molding thicknesses are listed in Table 2.

TABLE 1

| | Dwell time in | Pressure of | Targeted molding |
|---|---|---|---|
| | hot/cold press | hot/cold press | thickness |
| Sample | (seconds) | (bar) | (mm) |
| A | 5, 10, and 20 | 3.8 | 4.5 |
| Control of A | N/A | N/A | 4.5 |
| B | 5, 10, and 20 | 3.8 | 2.75 |
| Control of B | N/A | N/A | 2.75 |
| C | 5, 10, and 20 | 3.8 | 3 |
| Control of C | N/A | N/A | 3 |

The surface morphologies on the scrim side of the molded LWRT boards with and without post consolidation were investigated by scanning electron microscope. A small rectangular specimen was cut from the molded panel, coated with a thin layer of gold on the surface of interest (scrim side), and the surface morphology was examined under vacuum.

Mechanical tests were also conducted to evaluate the effects of the post consolidation process. Specimens for tests were cut out from the molded LWRT boards. The flexural properties of all the specimens were evaluated according to ASTM D790 dated 2017. Tensile tests were carried out as well, according to ASTM D5034 dated 2009.

### EXAMPLE 2

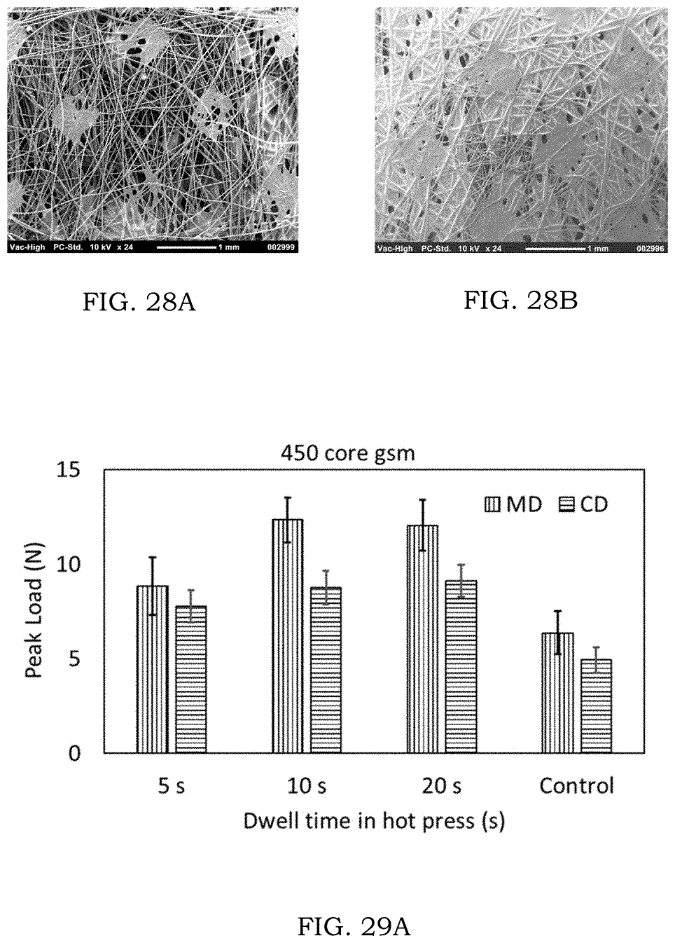

For LWRT composites, mechanical performance is highly dependent on the “wet-out” of resin on the surface of glass fibers. The extra post consolidation process was used to improve the adhesion between glass fiber and polypropylene (PP) resin. Surface morphology from SEM micrographs is a direct indicator of the degree of “wet-out” in the LWRT composite. Comparisons between molded samples without post consolidation and those with post consolidation using dwell times of twenty seconds, are shown in FIGS. 26A, 26B, 27A, 27B and 28A and 28B by checking the surface morphology of the scrim sides. FIGS. 26A (no post consolidation) and 26B (post consolidation) shows a 450 gsm core, FIGS. 27A (no post consolidation) and 27B (post consolidation) shows a 1000 gsm core, and FIGS. 28A (no post consolidation) and 28B (post consolidation) shows a 1000 gsm core.

For all the molded samples (450, 1000 and 1200 core gsm), the extra post consolidation process significantly changed the surface morphology of the scrim side. Without post consolidation, the scrim sides are highly porous, while the porosity is decreased significantly by the post consolidation process. It is an indication that the extra pressure and heating during post consolidation enhances spreading of the resin among the fibers in the core.

### EXAMPLE 3

Flexural properties are important for the handling of the LWRT sheets during the thermoforming process, in which the sheets are molded into articles such as headliners and attached to a fabric surface or other materials. If the LWRT sheets are not stiff or strong enough, wrinkles can appear on the surface due to bending deformation during handling, and even catastrophic failure of the sheets is possible.

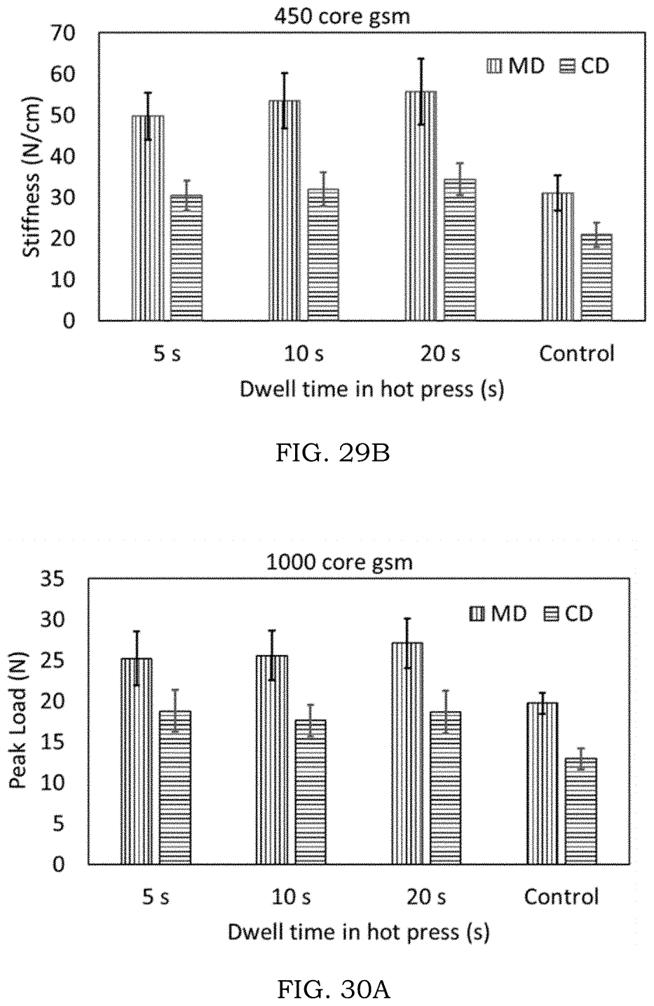

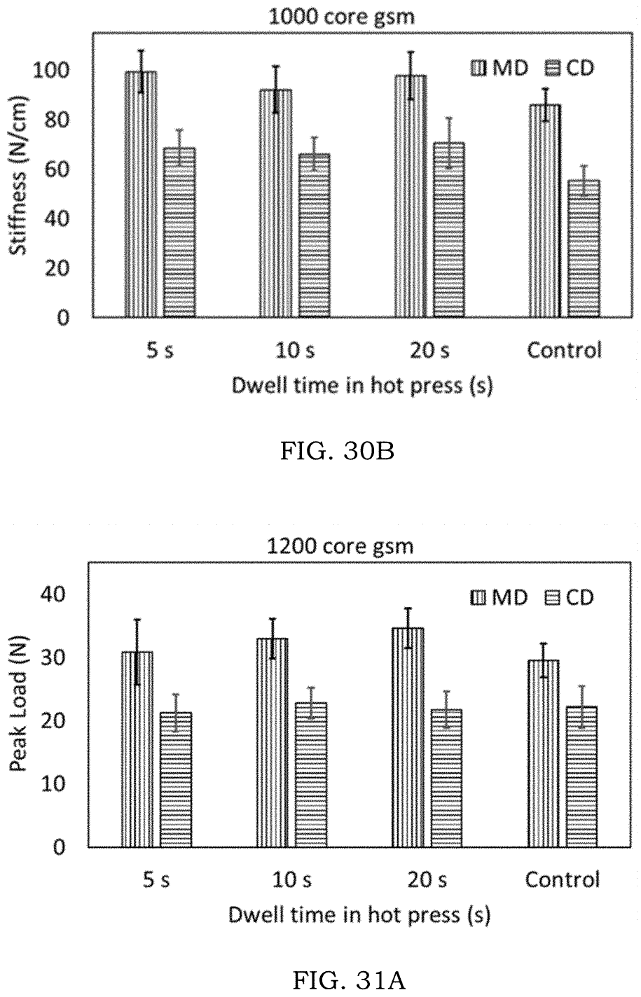

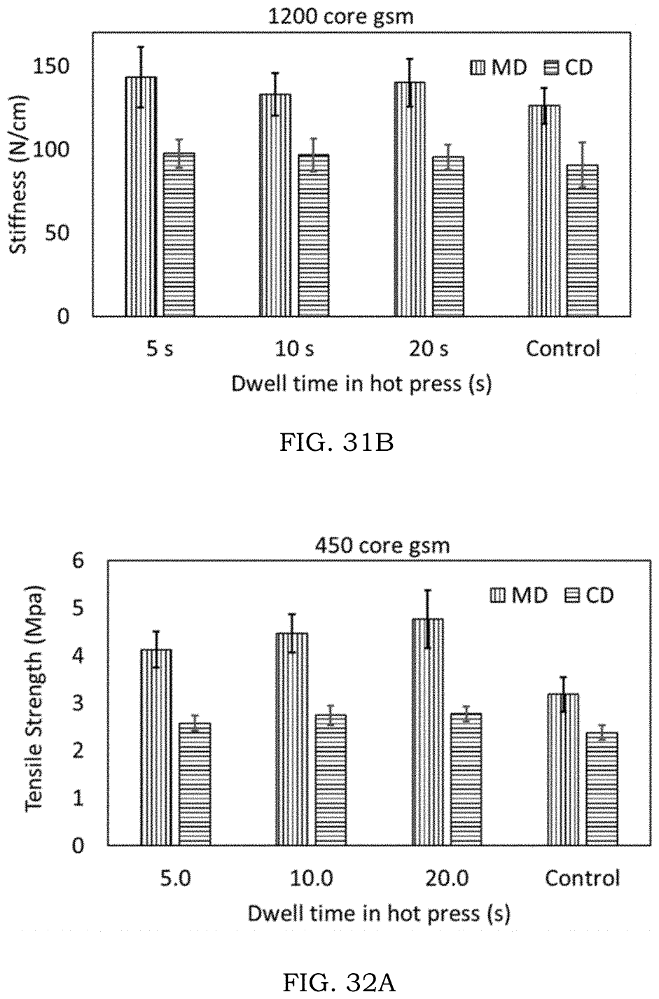

The flexural properties of all the specimens were evaluated. The flexural peak load and stiffness of the control and the post consolidated specimens for the 450 gsm core are shown in FIGS. 29A (peak load) and 29B (stiffness). The flexural peak load and stiffness of the control and the post consolidated specimens for the 1000 gsm core are shown in FIGS. 30A (peak load) and 30B (stiffness). The flexural peak load and stiffness of the control and the post consolidated specimens for the 1200 gsm core as shown in FIGS. 31A (peak load) and FIGS. 31B (stiffness). The right most bars of each graph is the control specimen and the rest are the post-consolidated specimens.

All the samples show significantly better results in machine direction (MD) than those in the cross-machine direction (CD). The aligning of fibers happens primarily in the head box during the web-forming part of the wet-laid process, and it generally favors the machine direction. The flow in the head-box is a mix of both shear and extension. There is strong shearing flow close to the walls and extensional flow toward the machine direction. As a result, the fibers are strongly aligned toward the flow direction leading to better mechanical performance in MD.

For the lightest 450 gsm core materials, the post consolidation improved both of the peak load and stiffness for all three dwell times. The longer the dwell time, the better the flexural performance. The use of the shortest time (5 seconds) improved the flexural properties from ˜39% to 60%. With the longest time (20 seconds), the least improvement of 65% was seen in CD for the stiffness, and the most improvement of 89% was achieved for peak load in MD.

For the 1000 gsm core materials, dwell time seems to have much less influence on the mechanical properties. According to t-test results, both peak load and stiffness of the post consolidated specimens still were improved by 14% (stiffness in CD) to 44% (peak load in CD) compared to the control.

For the heaviest 1200 gsm core materials, improvements were only realized for the peak loads according to the t-test, and there is no substantial enhancement for stiffness by the use of post consolidation. It is believed that increase the hot press temperature for the higher gsm boards could improve peak load and stiffness due to better wet out at the higher temperatures.

### EXAMPLE 4

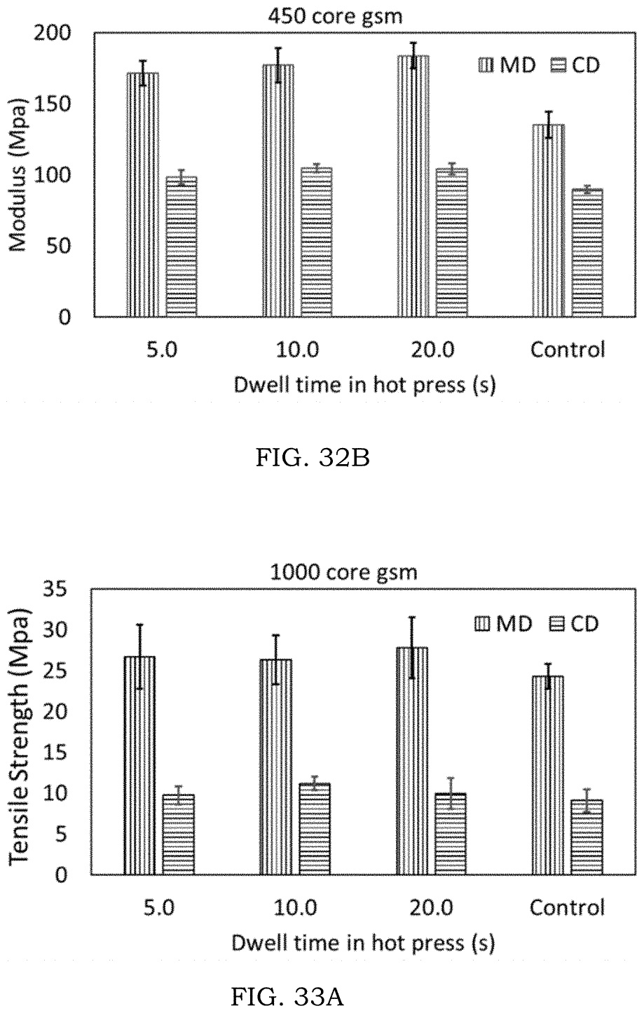

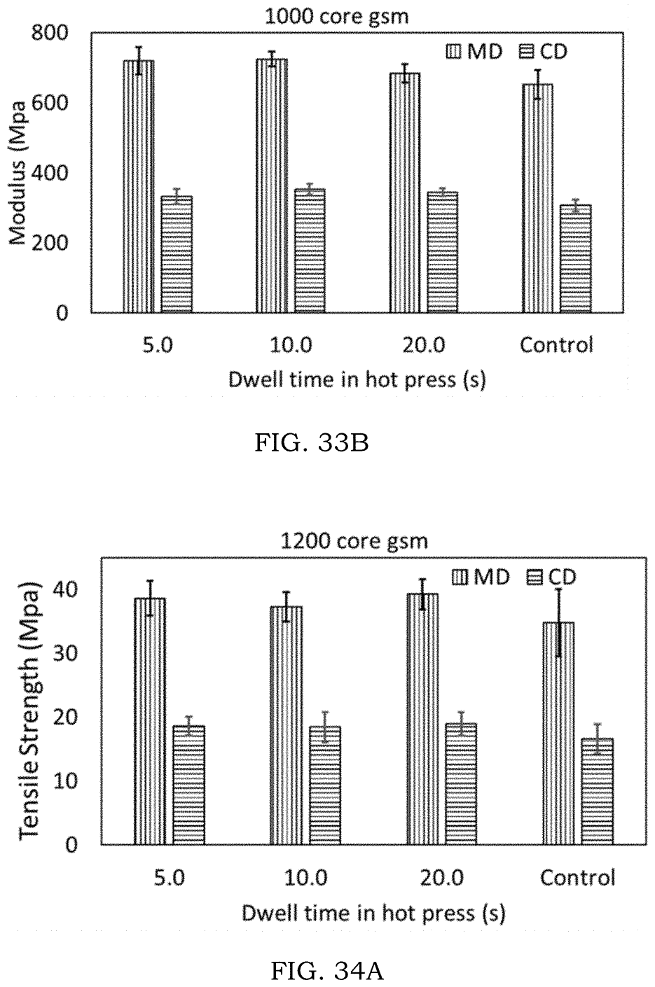

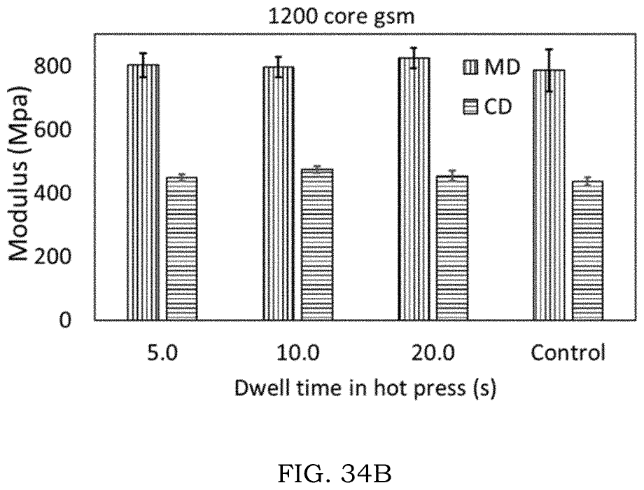

Tensile properties were also investigated. Tensile properties can be highly dependent on the bonding between resin and fibers. FIGS. 32A and 32B show the tensile strength (FIG. 32A) and modulus (FIG. 32B) for the 450 gsm core. FIGS. 33A and 33B show the tensile strength (FIG. 33A) and modulus (FIG. 33B) for the 1000 gsm core. FIGS. 34A and 34B show the tensile strength (FIG. 34A) and modulus (FIG. 34B) for the 1200 gsm core.

The measured results were very similar to those of the flexural properties. The dwell time affected the properties of the lightest 450 gsm core more than the heavier cores. As the basis weight increased, the improvement due to post consolidation decreased. For the 1200 gsm core, tensile strength in MD with a 20 second dwell time and the properties in CD with a 20 second dwell time are improved slightly, while there is no or minimal enhancement for the other dwell times. It seems that with a hot press temperature of 195° C., the post consolidation process favored and increase in properties for the lighter cores. Use of a higher temperature and/or pressures to promote better wet out is believed to increase tensile properties of the heavier cores.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, configurations, examples and embodiments have been described above, it will be recognized by the person of ordinary skill in the art, given the benefit of this disclosure, that additions, substitutions, modifications, and alterations of the disclosed illustrative aspects, configurations, examples and embodiments are possible.

1. An inline process for producing a lightweight thermoplastic composite article using an inline system, the inline process comprising:
combining reinforcing materials and a thermoplastic material in a liquid to produce an aqueous foam;
depositing the aqueous foam onto a moving support of the inline system;
removing liquid from the deposited aqueous foam on the moving support to form a web of open cell structures formed from the thermoplastic material and the reinforcing materials;
providing the formed web on the moving support of the inline system to a first press device of the inline system at a first pressure and a first temperature to apply heat and pressure to the formed web using the first press device, wherein the first temperature and first pressure are selected to melt the thermoplastic material of formed web;
providing the heated web to a second press device of the inline system at a second temperature and a second pressure to cool the heated web using the second press device, wherein the second temperature is below the melting point of the thermoplastic material of the heated web, wherein the second pressure is equal to or less than the first pressure, and wherein cooling of the heated web using the second press device provides a cooled web comprising a substantially similar thickness as the heated web; and
discharging the cooled web from the inline system to provide the lightweight thermoplastic composite article.

2. The inline process of claim 1, wherein the first pressure is greater than 1.1 bar or is about 2 bar to about 30 bar or is about 3 bar to about 25 bar or is about 3 bar to about 15 bar.

3. The inline process of claim 1, wherein the first, temperature is about 170 degrees Celsius to and about 250 degrees Celsius or about 170 degrees Celsius to about 240 degrees Celsius or about 170 degrees Celsius to about 230 degrees Celsius or about 170 degrees Celsius to about 220 degrees Celsius or about 170 degrees Celsius to about 210 degrees Celsius or about 170 degrees Celsius to about 200 degrees Celsius.

4. The inline process of claim 1, wherein the second temperature is less than a melting temperature of the thermoplastic material or is less than 170 degrees Celsius or is less than 160 degrees Celsius or less than 150 degrees Celsius or is less than 140 degrees Celsius or is less than 130 degrees Celsius or less than 120 degrees Celsius or is less than 110 degrees Celsius or is less than 90 degrees Celsius or less than 80 degrees Celsius or is less than 70 degrees Celsius or is less than 60 degrees Celsius or less than 50 degrees Celsius or is less than 45 degrees Celsius or is between 5 degrees Celsius and 45 degrees Celsius.

5. The inline process of claim 1, further comprising cutting the cooled web into individual lightweight thermoplastic composite articles using the inline system, and discharging the individual lightweight thermoplastic composite article from the inline system.

6. The inline process of claim 1, wherein the first press device is configured to apply pressure to the heated web at the first temperature and the first pressure by sandwiching the formed web between an upper plate and a lower plate.

7. The inline process of claim 1, wherein the second press device is configured to apply pressure to the heated web at the second temperature and the second pressure by sandwiching the heated web between an upper plate and a lower plate.

8. The inline process of claim 1, wherein the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to apply the first pressure to the formed web as the formed web passes between the set of upper rollers and the set of lower rollers of the first press device.

9. The inline process of claim 1, wherein the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to apply the second pressure to the heated web received from the first press device as the heated web passes between the set of upper rollers and the set of lower rollers of the second press device.

10. The inline process of claim 1, wherein the system comprises at least one set of rollers to select a thickness of the formed web prior to providing the formed web to the first press device.

11. An inline process for producing a lightweight thermoplastic composite article using an inline system, the inline process comprising:
combining reinforcing materials and a thermoplastic material in a liquid to produce an aqueous foam;
depositing the aqueous foam onto a moving support of the inline system;
removing liquid from the deposited aqueous foam on the moving support to form a web of open cell structures formed from the thermoplastic material and the reinforcing materials;
disposing a first skin on a first surface of the formed web;
providing the formed web and disposed first skin on the moving support of the inline system to a first press device of the inline system to apply heat and pressure to the formed web and disposed first skin at a first pressure and a first temperature using the first press device, wherein the first temperature and first pressure are selected to melt the thermoplastic material of formed web;
providing the heated web and disposed first skin to a second press device of the inline system at a second temperature to cool the heated web and disposed skin and apply pressure to the heated web at a second pressure using the second press device, wherein cooling of the heated web provides a cooled web comprising a substantially similar thickness as the heated web, wherein the second pressure is equal to or less than the first pressure; and
discharging the cooled web from the inline system to provide the lightweight thermoplastic composite article.

12. The inline process of claim 11, wherein the first pressure is greater than 1.1 bar or is about 2 bar to about 30 bar or is about 3 bar to about 25 bar or is about 3 bar to about 15 bar.

13. The inline process of claim 11, wherein the first temperature is about 170 degrees Celsius to and about 250 degrees Celsius or about 170 degrees Celsius to about 240 degrees Celsius or about 170 degrees Celsius to about 230 degrees Celsius or about 170 degrees Celsius to about 220 degrees Celsius or about 170 degrees Celsius to about 210 degrees Celsius or about 170 degrees Celsius to about 200 degrees Celsius.

14. The inline process of claim 11, wherein the second temperature is less than a melting temperature of the thermoplastic material or is less than 170 degrees Celsius or is less than 160 degrees Celsius or less than 150 degrees Celsius or is less than 140 degrees Celsius or is less than 130 degrees Celsius or less than 120 degrees Celsius or is less than 110 degrees Celsius or is less than 90 degrees Celsius or less than 80 degrees Celsius or is less than 70 degrees Celsius or is less than 60 degrees Celsius or less than 50 degrees Celsius or is less than 45 degrees Celsius or is between 5 degrees Celsius and 45 degrees Celsius.

15. The inline process of claim 11, further comprising cutting the cooled web into individual lightweight thermoplastic composite articles using the inline system, and discharging the individual lightweight thermoplastic composite article from the inline system.

16. The inline process of claim 11, wherein the first press device is configured to apply pressure to the heated web at the first temperature and the first pressure by sandwiching the formed web between an upper plate and a lower plate.

17. The inline process of claim 11, wherein the second press device is configured to apply pressure to the heated web at the second temperature and the second pressure by sandwiching the heated web between an upper plate and a lower plate.

18. The inline process of claim 11, wherein the first press device comprises a set of upper rollers and a set of lower rollers with a space between the set of upper rollers and the set of lower rollers of the first press device, wherein each of the plurality of upper rollers and the plurality of lower rollers of the first press device is heated to the first temperature and together are used to apply the first pressure to the formed web as the formed web passes between the set of upper rollers and the set of lower rollers of the first press device.

19. The inline process of claim 11, wherein the second press device and the second press device comprises a set of upper rollers and a set of lower rollers with a space between the set of upper rollers and the set of lower rollers of the second press device, wherein each of the plurality of upper rollers and the plurality of lower rollers of the second press device is cooled to the second temperature and together are used to apply the second pressure to the heated web received from the first press device as the heated web passes between the set of upper rollers and the set of lower rollers of the second press device.

20. The inline process of claim 11, wherein the system comprises at least one set of rollers to select a thickness of the formed web prior to providing the formed web to the first press device.

21-88. (canceled)
